(19) United States
(12) Patent Application Publication
(10) Pub. No.: US 2025/0387900 A1
(43) Pub. Date: Dec. 25, 2025

(54) EXOSKELETON FOR LUMBAR SUPPORT

(71) Applicant: TECHNOLOGIES BIOLIFT INC., Montreal (CA)

(72) Inventors: Mathieu RAMANANARIVO, Montreal (CA); Samuel LECOURS, Boucherville (CA); Laurent BLANCHET, Bromont (CA); Yann SCHAUMLOEFFEL, Montreal (CA); Yann ZIMMERMAN, Montreal (CA)

(21) Appl. No.: 19/165,044

(22) PCT Filed: Mar. 15, 2024
(86) PCT No.: PCT/CA2024/050315

§ 371 Date: Sep. 12, 2025

Related U.S. Application Data
(60) Provisional application No. 63/490,595, filed on Mar. 16, 2023.

(51) Int. Cl. B25J 9/00

(52) U.S. Cl. CPC B25J 9/0006

(57) ABSTRACT

An exoskeleton is provided and includes a garment to be worn by a user, an exoskeleton interface provided on a backside of the user when wearing the garment, and an exoskeleton mechanism adapted to be connected to the garment via the exoskeleton interface. The exoskeleton mechanism includes an actuator system having a spring-loaded assembly coupled a torso anchor and pivotally coupled to a waist anchor, and a resilient element connected to the casing. The spring-loaded assembly is operable to generate a force upon deformation or deflection of the resilient element. The exoskeleton mechanism also includes actuator links rotatably coupled between the waist anchor and respective thigh anchors. Each actuator link is operatively coupled to and adapted to operate the spring-loaded assembly upon rotation of the casing or the actuator links. The force generated upon operation of the spring-loaded assembly is transferred to the user via the exoskeleton interface and the garment to assist the user in performing a movement.

### TECHNICAL FIELD

The technical field generally relates to exoskeletons for assisting in performing tasks, and more specifically relates to exoskeletons for providing support to the lumbar region of users.

### BACKGROUND

Workplace injuries are the 2nd leading cause of disability in the world. According to the Institut National de Santé Publique du Québec (INSPQ), approximately 25% of workers (Tissot et al. 2020) live with pain due to a musculoskeletal disorder (MSD) caused by a workplace injury.

Common injuries or lesions among workers include tendonitis, bursitis, epicondylitis and sprains, which generally occur in the back, shoulders, neck, elbows or wrists in descending order of importance. The main causes of these injuries include: handling heavy loads, repetitive movements, unusual, uncomfortable or prolonged static positions, vibrations, insufficient recovery time and a fast-paced work environment (Gélinas et al., 2019). Depending on the severity of these injuries, they result in an absence from work ranging from a few weeks to several months and, in some cases, can lead to permanent worker disability. These injuries involve significant costs for both the employer and society (Gélinas et al., 2019).

In recent years, robotics and automation have made it possible to replace the role of workers in many high-risk injury tasks. However, there are still many tasks that benefit from the human precision, skills and movement capabilities unique to workers (Huysamen et al., 2018). To assist workers in their tasks and reduce exposure to injuries, the use of exoskeleton devices is a promising avenue. Indeed, these devices allow mechanical power to be transferred from the exoskeleton to the human body, thus reducing the biomechanical efforts to be developed by the worker. For back injuries, an exoskeleton can be used to reduce back strain by redistributing the effort through the exoskeleton.

In addition to the exoskeleton's main objective of physical assistance, it should not impair the complex movements of the human body. Providing at least both of these functionalities involves various challenges and there is a need for enhanced technologies in this field.

### SUMMARY

According to an aspect of the present disclosure, an exoskeleton is provided. The exoskeleton includes a garment adapted to be worn by a user and comprising a torso attachment to be worn around a torso, a waist attachment to be worn around a waist; and a pair of thigh attachments to be worn around corresponding thighs. The exoskeleton also includes an exoskeleton interface comprising a torso anchor connectable to the torso attachment, a waist anchor connectable to the waist attachment; and a pair of thigh anchors connectable to respective thigh attachments, the torso anchor, the waist anchor and the pair of thigh anchors being provided on a backside of the user when wearing the garment. The exoskeleton has an exoskeleton mechanism adapted to be connected to the garment via the exoskeleton interface and includes an actuator system. The actuator system includes a spring-loaded assembly having a casing adapted to be coupled the torso anchor and pivotally coupled to the waist anchor, and a resilient element connected to the casing, the spring-loaded assembly being operable to generate a force upon deformation or deflection of the resilient element. The actuator system further includes a pair of actuator links rotatably coupled to the waist anchor at a first end thereof and connected to respective thigh anchors at a second end thereof, the pair of actuator links being operatively coupled to the spring-loaded assembly such that the spring-loaded assembly is operated upon rotation of at least one of the casing and either one or both of the pair of actuator links about the waist anchor, wherein the force generated upon operation of the spring-loaded assembly is transferred to the torso anchor and to the torso attachment to assist the user in performing a movement and/or a corresponding task.

According to a possible embodiment, the exoskeleton mechanism further comprises an adaptative system comprising adaptative links configured to dynamically adjust the relative distances between at least two of the torso anchor, the waist anchor and the thigh anchors during movement of the user.

According to a possible embodiment, the adaptative links comprise at least one of a sliding link configured to adjust a distance between two of the anchors and a pivot link configured to adjust an angle between two of the anchors.

According to a possible embodiment, the sliding link comprises a pair of complementing rails shaped and adapted to slide along one another.

According to a possible embodiment, the torso anchor and the waist anchor are coupled together by at least one sliding link configured to adjust a distance therebetween.

According to a possible embodiment, the torso anchor and the waist anchor are coupled together by at least a first pivot link defining a pivot axis and enabling relative rotation of the torso anchor and the waist anchor about the pivot axis.

According to a possible embodiment, each one of the pair of actuator links and the waist anchor are coupled together at the first pivot link to enable rotation of the actuator links about the first pivot axis.

According to a possible embodiment, each one of the pair of actuator links are pivotally coupled to the waist anchor at respective pivot joints such that each actuator link is adapted to pivot about respective pivot axes.

According to a possible embodiment, each pivot axis is parallel relative to one another.

According to a possible embodiment, each pivot axis is aligned with one another.

According to a possible embodiment, each one of the pair of actuator links and the waist anchor are coupled together by respective second pivot links defining second pivot axes and enabling rotation of the pair of actuator links about a corresponding one of the second pivot axes.

According to a possible embodiment, the second pivot axes are substantially perpendicular to the first pivot axis.

According to a possible embodiment, the actuator system comprises a coupling joint connected to the resilient element of the spring-loaded assembly at a connection point, and further comprises a spring actuator operatively coupled between the actuator links and the coupling joint to establish an operational connection between the actuator links and the spring-loaded assembly.

According to a possible embodiment, the spring actuator comprises a cable extending between the actuator links and the coupling joint, wherein rotation of the actuator links tensions the cable and pulls on the coupling joint and the resilient element, thereby generating the force by deformation or deflection of the resilient element.

According to a possible embodiment, the spring actuator comprises a single cable extending from a first one of the pair of actuator links, through the coupling joint and to a second one of the pair of actuator links.

According to a possible embodiment, the coupling joint is pivotally coupled to the waist anchor at a coupling pivot link, and wherein the resilient element, when deformed or deflected, defines an axial force adapted to generate a torque about the coupling pivot link.

According to a possible embodiment, the casing of the spring-loaded assembly is adapted to transfer the torque to the torso anchor and the torso attachment.

According to a possible embodiment, the actuator system comprises a force adjuster selectively operable to adjust a distance between the resilient element and the waist anchor in order to adjust the torque generated by the axial force generated by the resilient element.

According to a possible embodiment, the force adjuster is operable to move the connection point joining the coupling joint to the spring-loaded assembly relative to the coupling pivot link.

According to a possible embodiment, the force adjuster is toolessly operable.

According to a possible embodiment, the force adjuster comprises an endless screw extending through and connecting the coupling joint to the spring-loaded assembly, the connection point being defined along the endless screw, and wherein rotation of the endless screw adjusts the position of the connection point therealong.

According to a possible embodiment, the actuator system comprises a distributor mechanism configured to distribute the force generated by the spring-loaded assembly substantially evenly between each one of the pair of actuator links such that a substantially even force is transferred to each one of the thigh attachments.

According to a possible embodiment, the distributor mechanism comprises a pulley mounted to the coupling joint, and wherein the cable extends from the first one of the pair of actuator links, through the pulley and the coupling joint and to the second one of the pair of actuator links.

According to a possible embodiment, the exoskeleton mechanism further comprises an activation mechanism selectively operable between an engaged mode, where operation of the exoskeleton mechanism is enabled to allow the force generated upon operation of the spring-loaded assembly to define a transferred force transferrable to the torso anchor and to the torso attachment to assist the user, and a disengaged mode.

According to a possible embodiment, the exoskeleton mechanism is adapted to transfer between 0% and 15% of the transferred force to the torso anchor and to the torso attachment when operating the activation mechanism in the disengaged mode.

According to a possible embodiment, operation of the activation mechanism in the engaged mode establishes a direct mechanical connection between the torso anchor and the spring-loaded assembly to enable transfer of the transferred force, and wherein operation of the activation mechanism in the disengaged mode breaks the direct mechanical connection between the torso anchor and the spring-loaded assembly, thereby preventing a complete transfer of the transferred force.

According to a possible embodiment, the activation According to a possible embodiment, mechanism comprises a hook coupled to the torso anchor and adapted to connect to a latch of the spring-loaded assembly when operating the activation mechanism in the engaged mode.

According to a possible embodiment, the activation mechanism is toolessly operable between the engaged and disengaged modes.

According to a possible embodiment, the activation mechanism comprises a switch operatively coupled to the hook and being selectively operable to actuate the hook to operate the activation mechanism in a desired one of the engaged and disengaged modes.

According to a possible embodiment, the switch is connected to the hook via a wire, and wherein the switch is manually displaceable to effect rotation of the hook to operate the activation mechanism between the engaged and disengaged modes.

According to a possible embodiment, the switch is adapted to be worn on the garment to facilitate access.

According to a possible embodiment, the exoskeleton mechanism is adapted to define a mechanical connection with the torso anchor during movement of the user to enable the transfer of the force generated by the spring-loaded assembly to the torso anchor and to the torso attachment, and wherein the exoskeleton mechanism further comprises an offset mechanism operable to adjust a range of motion allowed by the user prior to defining the mechanical connection between the torso anchor and the exoskeleton mechanism.

According to a possible embodiment, the offset mechanism comprises a set screw coupled to one of the torso anchor and the exoskeleton mechanism and being rotatable to adjust a relative distance between the torso anchor and the exoskeleton mechanism.

According to a possible embodiment, the offset mechanism is toolessly operable.

According to a possible embodiment, the resilient element comprises at least one of a spring, a piston, a gas cylinder, an elastic or a combination thereof.

According to a possible embodiment, the torso anchor comprises an upper support plate connected to the torso attachment and configured to engage the user's back proximate the shoulder blades.

According to a possible embodiment, the upper support plate comprises a pair of upper back plates spaced from one another to define a gap therebetween, and wherein the pair of upper back plates are configured to engage the user's back to align a spine of the user with the gap to at least partially prevent applying pressure to the spine.

According to a possible embodiment, the waist anchor comprises a lower support plate connected to the waist attachment and configured to engage the user's lumbar region.

According to a possible embodiment, the lower support plate comprises a pair of lateral wings spaced from one another to define a gap therebetween, and wherein the pair of lateral wings are configured to engage the user's lumbar region on respective sides of a spine of the user to at least partially prevent applying pressure to the spine.

According to a possible embodiment, the waist attachment corresponds to a tool belt or is adapted to be replaced by a tool belt.

According to a possible embodiment, the exoskeleton mechanism is configured to be contained on the backside of the user when wearing the garment in order to free up front and lateral sides of the user.

According to a possible embodiment, the exoskeleton mechanism is configurable between an operational configuration, where the pair of actuator links extend downwardly from a bottom end of the spring-loaded assembly, and a stowed configuration, where the actuator links extend upwardly from the bottom end of the spring-loaded assembly.

According to a possible embodiment, the pair of actuator links are pivotable relative to the spring-loaded assembly to enable folding the exoskeleton from the operational configuration to the stowed configuration.

### BRIEF DESCRIPTION OF THE DRAWINGS

FIG. 1 is a representation of different anatomical planes.

FIG. 2 is a rear view of an exoskeleton worn by a subject, according to an embodiment.

FIG. 3 is a rear perspective view of an exoskeleton worn by a subject, showing a torso attachment and a waist attachment, according to an embodiment.

FIG. 4 is a rear view of the exoskeleton shown in FIG. 3, showing a spring-loaded assembly mounted between the torso attachment and the waist attachment, according to an embodiment.

FIGS. 5 and 6 are side views of the exoskeleton shown in FIG. 3, showing actuator links extending between the waist attachment and the thighs of the user, according to an embodiment.

FIG. 7 is a perspective view of an exoskeleton mechanism, showing a cable connecting each actuator link to the spring-loaded assembly, according to an embodiment.

FIG. 8 is a rear view of the exoskeleton mechanism shown in FIG. 7, showing a coupling point around which the cable extends, according to an embodiment.

FIG. 9 is a side view of the exoskeleton mechanism shown in FIG. 7, showing a plurality of connection points for connecting the cable, according to an embodiment.

FIG. 10 is a side view of the exoskeleton mechanism shown in FIG. 7, showing a force being generated by the spring-loaded assembly upon movement made by the user, according to an embodiment.

FIGS. 11 and 12 are schematic representations of an adaptative system of the exoskeleton enabling dynamic adjustments thereof, showing the subject in a standing position (FIG. 11) and a bent position (FIG. 12), according to an embodiment.

FIGS. 13A to 13D are schematic representations of adaptative systems according to possible alternate embodiments.

FIG. 14 is a rear view of a portion of the exoskeleton, showing a pivot connection between the actuator links and the waist attachment, according to an embodiment.

FIGS. 15 and 16 are rear perspective views of the exoskeleton in use by a moving subject, according to possible embodiments.

FIG. 17 is a rear view of a portion of the exoskeleton mechanism, showing an activation mechanism, according to an embodiment.

FIG. 18 is a schematic representation of forces applied to a subject's body while using the exoskeleton, according to an embodiment.

FIGS. 19 and 20 are rear and side views of an alternate embodiment of the exoskeleton, showing support plates for the torso attachment and the waist attachment.

FIGS. 21 and 22 show textile padding coupled to the support plates shown in FIGS. 19 and 20.

FIGS. 23 to 26 are front views of a switch of the activation mechanism, showing the switch in various positions for operation of the activation mechanism, according to an embodiment.

FIGS. 27 and 28 are rear views of the exoskeleton shown in FIGS. 19 and 20 worn by a subject.

FIGS. 29 and 30 a rear perspective views of an actuator system of the exoskeleton mechanism, according to an embodiment.

FIG. 31 is a rear perspective view of a kneeling subject wearing the exoskeleton, showing the asymmetric movement of actuator arms, according to an embodiment.

FIG. 32 is a side view of the exoskeleton mechanism shown in FIG. 27, showing a coupling joint connected between the spring-loaded assembly and the waist attachment, according to an embodiment.

FIGS. 33 to 36 are side views of the exoskeleton mechanism shown in FIG. 32, showing a force adjuster operable to adjust a relative distance between components, according to an embodiment.

FIGS. 37A and 37B are partial side views of the exoskeleton mechanism shown in FIG. 32, showing an activation mechanism in a disengaged mode (FIG. 37A) and an engaged mode (FIG. 37B), according to an embodiment.

FIGS. 38 and 39 are partial side views of the exoskeleton mechanism shown in FIG. 32, showing an offset mechanism operable to adjust adjust a range of motion allowed prior to establishing the mechanical connection between two components, according to an embodiment.

FIGS. 40 and 41 are perspective and side views of the exoskeleton shown in FIG. 27, in a stowed configuration.

### DETAILED DESCRIPTION

In some implementations, the present disclosure describes systems and apparatuses to be worn by a user for assisting in the performance of various tasks. The system includes an exoskeleton adapted to facilitate the performance of certain tasks by assisting the user by storing and releasing mechanical energy. The exoskeleton includes different mechanisms configured to cooperate in order to store energy during movement of the user, and release, redistribute or otherwise generate energy, for example, as directional forces, in desired locations or anatomic regions to provide support to the user or facilitate a movement where and/or when required.

In the present disclosure, the exoskeleton includes an exoskeleton mechanism operable to store and release forces, and a garment provided with an exoskeleton interface adapted to create a connection between the user and the exoskeleton mechanism. As will be described further below, movement of the user is transmitted to the exoskeleton mechanism via the exoskeleton interface for enabling operation of the exoskeleton mechanism. The movement of the user drives displacement of the corresponding sections of the exoskeleton mechanism, which operates the exoskeleton mechanism for generating a force. The exoskeleton mechanism is configured to transfer the generated force to another section of the exoskeleton mechanism, which is transmitted to the body of the user via the exoskeleton interface, to aid the user in performing a task or completing a given movement. The exoskeleton can include an upper body portion, a midsection portion and a lower body portion operatively connected to one another and adapted to cooperate to assist the user in performing physical tasks. It is thus appreciated that the garment includes corresponding portions to enable the user to interface with each portion of the exoskeleton mechanism across the different areas/locations of the body.

The exoskeleton interface includes a plurality of interface anchors configured to connect the exoskeleton mechanism to the garment. The interface anchors can include a connection joint provided proximate the midsection portion for operatively coupling the upper body and lower body portions together. Particularly, the connection joint is adapted to enable relative movement of the upper body portion and the lower body portion. Therefore, it is noted that the connection joint assists in enabling unhindered movements of the user, such as flexion of the hips, for example. The garment is configured to be worn by the user in a manner positioning the exoskeleton mainly along his/her back, with connections defined between the exoskeleton and the user's back, waist and thighs. In other words, if the user's body was divided in half by a frontal plane, defining front and rear portions, the exoskeleton mechanism is configured to be contained in a rear portion.

In addition, the upper and lower body portions can be coupled to the interface via respective interface anchors configured to assist in allowing at least partially unhindered movement of the user. The exoskeleton mechanism can include an adaptative system configured to dynamically adjust the relative distance between the different portions of the exoskeleton mechanism during movements performed by the user (e.g., flexion, extension, etc.). The adaptative system includes adaptative links configured to dynamically adjust relative distances at least between the interface anchors during movement of the user.

It should be understood that, as used herein, the expression “dynamically” refers to the ability of the exoskeleton, or related systems, to be adjusted or perform adjustments during standard operations. As such, in some embodiments, the adjustments made to the exoskeleton can be made without having to stop performing the task at hand and/or manually adjust the exoskeleton, either personally or by another person. In other words, adjustments to the exoskeleton can be made “in real time” without direct and/or explicit interaction with the exoskeleton.

It is noted that dynamically adjusting the exoskeleton mechanism, for example, while performing certain tasks, allows the exoskeleton mechanism to be positioned in a desired location and/or configuration relative to the user. For example, in some embodiments, the exoskeleton mechanism is positioned behind the user, thereby freeing up the front and the sides of the user, while also reducing the risk of bumping against parts of the exoskeleton during certain movements. The adaptative system is further adapted to enable operation of the exoskeleton mechanism by users of varying body types (e.g., big, small, tall, short, etc.). As will be described further below, relative distances between various sections of the exoskeleton can be adjusted (e.g., dynamically), thereby enabling users of various shapes and sizes. The exoskeleton is configured to at least partially autonomously adjust to the size of the user by adjusting the relative distances between its different sections upon adorning the exoskeleton and during movement of the user.

The exoskeleton mechanism also includes an actuator system configured to store and release support forces during movement of the user in order to assist the user in performing said movement and/or a corresponding task. The actuator system includes a spring-loaded assembly connected to and extending between the upper body portion and the midsection portion, and further includes actuator links operatively coupled between the lower body portion and the spring-loaded assembly. Upon movement of the user, for instance, when bending forward (e.g., hip flexion), the actuator links actuate the spring-loaded assembly to compress a resilient element, thereby generating and storing a spring-generated force. The exoskeleton is configured to transfer the spring-generated force to the upper and lower body portions to assist certain movements of the user, such as hip extensions, to stand back up (e.g., after having bent forward). The connection between the lower body portion, the midsection portion and the upper body portion enables transmission of the transferred force to support the upper body portion and assist movement of the user. In other words, the exoskeleton “leans” on the waist and thighs of the user to support the torso/upper body of the user. The exoskeleton components are configured such that the transferred forces are substantially perpendicular relative to the body of the user. This configuration increases comfort and ease-of-use while operating (e.g., wearing) the exoskeleton, which can lead to an increase in efficiency in performing various tasks.

It should be understood that, as used herein, the expression “spring-loaded assembly” refers to a subsystem or assembly of the exoskeleton which, upon actuation/operation thereof, generates a force. The spring-loaded assembly should therefore not be limited to including a spring, but any suitable and/or known device or mechanism, or combination of devices and mechanisms, adapted to generate a force upon actuation. Similarly, the expression “resilient element”, as used herein, refers to a component of the exoskeleton, which is adapted to recoil, revert or “spring back” into shape after being deformed, for example, via bending, stretching or being compressed.

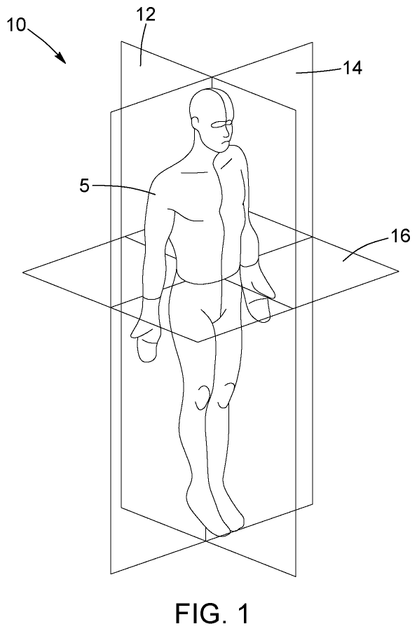

With reference to FIG. 1, a reference diagram of a body 10 of a human user or subject 5 illustrating three primary planes of movement, as is known in the art, is illustrated. As used herein, a sagittal plane 12 defines a plane that vertically divides the body 10 in right and left halves. A frontal plane 14 is illustrated as a plane that is perpendicular relative to the sagittal plane 12, vertically dividing the body 10 of the user 5 in front and back halves. A transverse plane 16 is illustrated as a plane that is horizontally dividing the body 10 in top and bottom halves.

In a normal human body 10, pelvis and hips 18 allows rotation of an upper body 20 of the human user with three degrees of freedom, i.e., about the sagittal plane 12, the frontal plane 14, and the transverse plane 16. Similarly, the pelvis and hips 18 also allows each thigh 22 to also rotate with respect to the pelvis 18 with three degrees of freedom.

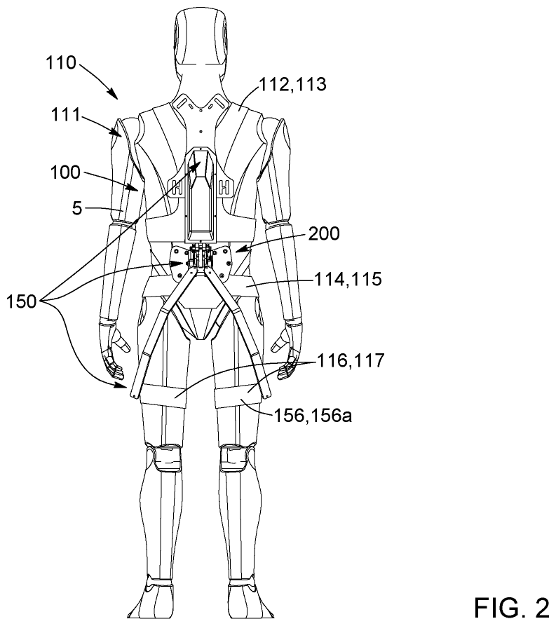

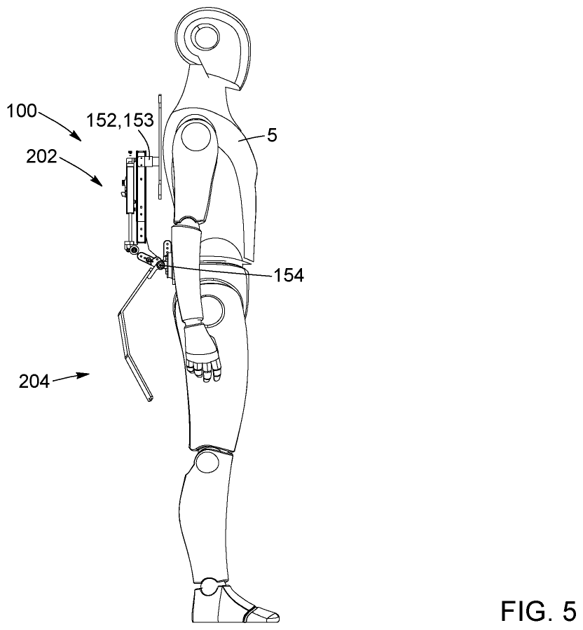

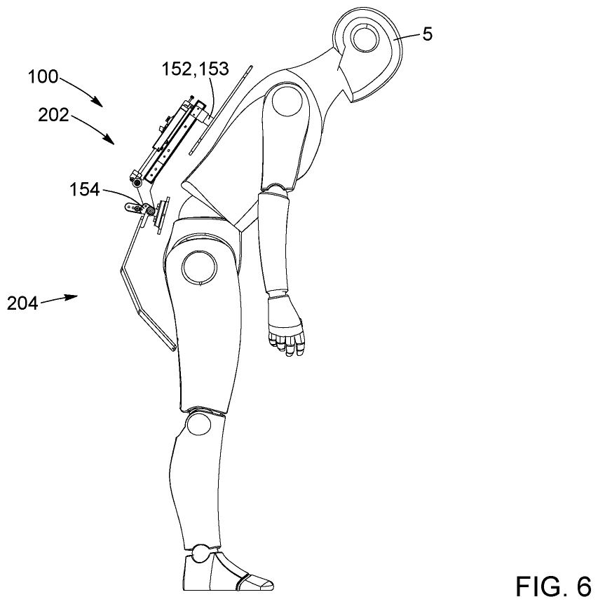

Now referring to FIGS. 2 to 6, an exoskeleton 100 according to an embodiment is illustrated. The exoskeleton 100 includes a rigid mechanism having a plurality of joints, such as rotational and translational joints configured to allow freedom of movement of the subject. More specifically, the exoskeleton 100 is adapted for lower back support, such as the lumbar region of the user. Therefore, it is noted that the joints of the exoskeleton are configured to allow freedom of movement of the user's 5 hips and lower back. The exoskeleton enables substantially normal movement and does not create discomfort by unusual movements and/or postures. For instance, the user can comfortably be in a standing position, perform lateral hip flexions and hip extensions, hip abductions and adductions, trunk rotations, and any suitable combinations of these movements. As will be described further below, the exoskeleton 100 is configured to be worn mainly on the back side of the user, that is, in a rear half of the frontal plane. This configuration allows for the sides (and front) of the user to remain substantially free of exoskeleton components, thus improving maneuverability and flexibility of the user. The exoskeleton is also configured so as to improve adaptability of its components by the user and be generally more ergonomic.

In this embodiment, the exoskeleton 100 includes a wearable portion, such as one or more garments 110 (e.g., vest, pants, harness, etc.), an exoskeleton mechanism 200 configured to provide physical assistance to the user, and an exoskeleton interface 150 for operatively connecting the exoskeleton mechanism 200 to the garment 110, and thereby, to the user. As will be described further below, operation of the exoskeleton mechanism 200 is accomplished via movement of the user. In other words, to obtain physical assistance from the exoskeleton 100, a user simply has to be wearing the exoskeleton (e.g., wearing the garment 110) and perform a task which includes movement of the lumbar region and/or hips.

As seen in FIG. 2, the garment 110 can include a harness 111 having an upper body portion 112, such as a torso attachment 113 (e.g., a vest), a midsection portion 114, such as a waist attachment 115 (e.g., a waistbelt) and a lower body portion 116, such as leg or thigh attachments 117 (e.g., a pair of leg loops). It is noted that the different portions of the harness 111 are connected to one another via any suitable and/or known method, such as via straps (elastic or not), buckles, belts, etc. Each portion can also be adjustable, independently to enable users of varying body types to wear the harness 111.

In some embodiments, the exoskeleton interface 150 can include couplings or anchors for each portion of the garment 110. For example, the exoskeleton interface 150 can include a torso anchor 152 adapted to enable connection of the exoskeleton mechanism 200 to the torso attachment 113 of the harness 111. Similarly, the waist attachment 115 can include a waist anchor 154 adapted to enable connection of the exoskeleton mechanism 200 to the waist attachment 115, and the thigh attachments 117 can each include thigh anchors 156 adapted to enable connection of the exoskeleton mechanism 200 to each thigh attachment 117. It is thus noted that the various anchors of the exoskeleton interface 150 define interfaces between the exoskeleton mechanism 200 and the corresponding portion of the harness 111 such that movements of the user causes movement of the garment 110, which in turn engages the exoskeleton mechanism 200 via the exoskeleton interface 150.

In this embodiment, the anchors of the exoskeleton interface 150 are positioned behind the user to free up the front and the sides of the user. More particularly, and as seen in FIGS. 2 to 6, the torso anchor 152 can be positioned on the back of the user (e.g., along the thoracic region), the waist anchor 154 can also be positioned on the back of the user, below the torso anchor 152 (e.g., along the lumbar region), and the thigh anchors 156 can be positioned about the user's thighs on a rear side thereof (e.g., along the hamstrings). It is appreciated that the anchors are all positioned on a common side of the frontal plane 14 represented in FIG. 1.

The anchors of the exoskeleton interface 150 are configured to effect movement and/or operation of the exoskeleton mechanism. For example, the anchors can define joints, such as ball joints or pivot joints between the exoskeleton mechanism and the garment. In this embodiment, the torso anchor 152 and both of the thigh anchors 156 correspond to a ball joint connection (e.g., for a total of three (3) ball joint connections), while the waist anchor 154 corresponds to a pivot joint connection. It is thus noted that, in this embodiment, the anchors can be configured to allow rotational movements about one or more axes but prevent translational movement in any direction. However, it is appreciated that other configurations are possible. The ball joint connection of the torso anchor 152 can be defined by a block 153 of resilient and flexible material, such as rubber.

In some embodiments, each portion of the harness 111 can include a pocket or sleeve, and each anchor of the exoskeleton interface 150 can include an insert adapted to be positioned and secured in a corresponding one of the sleeves. As such, it is appreciated that the anchors are coupled to the inserts, which can be secured to the garment for transmitting forces from the exoskeleton mechanism 200 to the garment, and therefore, to the user. The inserts can include a torso insert 152a, a waist insert 154a and thigh inserts 156a, and can be made of sufficiently rigid material to enable securely coupling the anchors thereto, and can be secured to the harness 111 using different means, such as, but not limited to stitching, fastening, snapping, or a combination thereof.

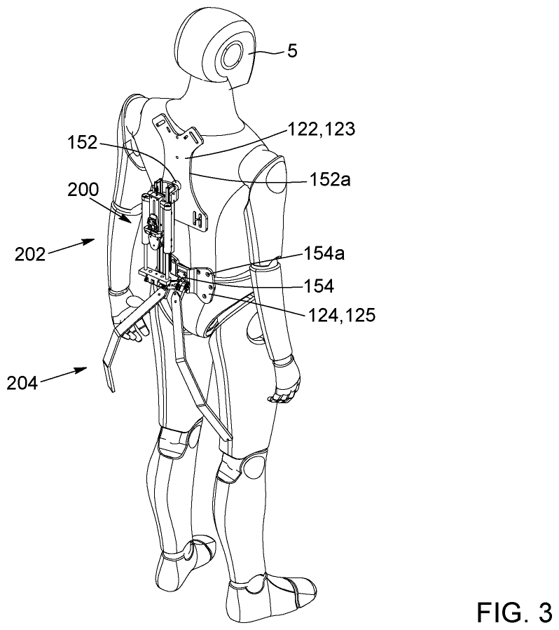

In some embodiments, the inserts can include support plates 120 adapted to engage (e.g., abut, contact) the user to improve comfort and conformity of the exoskeleton with the body of the user. The support plates 120 can engage predetermined parts of the body of the user such as along his/her back, for instance. With reference to FIG. 3, the support plates 120 can include an upper portion plate 122 (e.g., the torso insert 152a) configured to engage the upper body portion of the user's back, and a lower portion plate 124 (e.g., the waist insert 154a) configured to engage the lower portion of the user's back. More specifically, the upper portion plate 122 can include a back plate 123 shaped and sized to engage with the back of the user between the shoulder blades (e.g., below the neck) and at least partially along the ribs. The back plate 123 can have a generally “X” shape to partially conform to the morphology of the user, for instance, to extend between and around the shoulder blades of the user (e.g., along the thoracic portion of the spine).

In the embodiment of FIG. 3, the lower portion plate 124 includes a lumbar plate 125 shaped and sized to engage with the lumbar region of the user's back. In some embodiments, the lumbar plate 125 is contained above the hip bones of the user, while in alternate embodiments, the lumbar plate 125 at least partially overlaps with the hip bones. In addition, the back plate 123 and the lumbar plate 125, as shown in FIG. 3, can be generally symmetrical and arranged centrally along the user's back. Therefore, the back plate 123 and the lumbar plate 125 can provide substantially the same support on left and right sides of the user. In the illustrated embodiment, the back plate 123 and the lumbar plate 125 extend across the user's spine. However, it is appreciated that other configurations are possible.

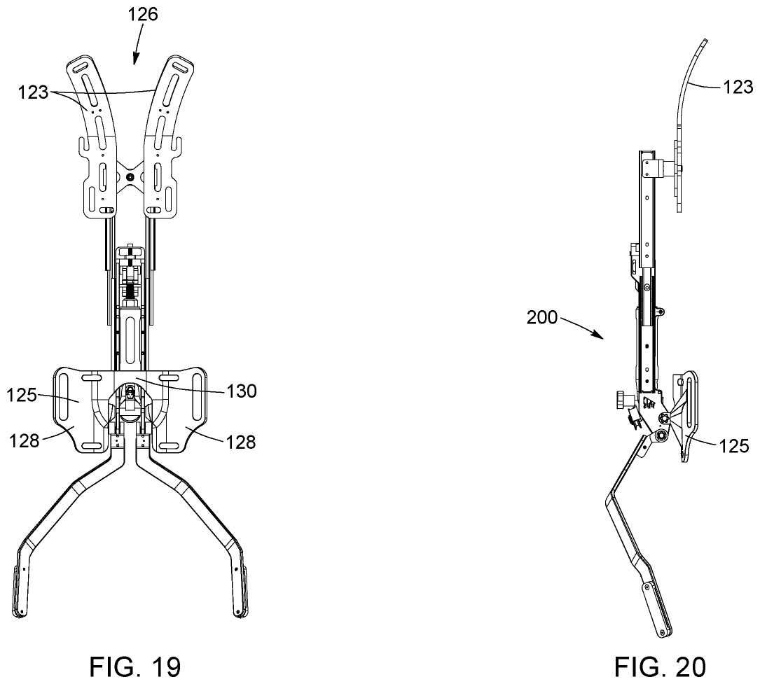

For instance, and with reference to FIGS. 19 and 20, the back plate 123 and the lumbar plate 125 can be shaped and sized so as to at least avoid overlapping with the user's backbone/spine. More specifically, the back plate 123 can include a pair of back plates 123 spaced from one another so as to define a gap 126 therebetween. In this embodiment, the pair of back plates 123 are shaped, sized and configured to engage the user's back on either side of the spine. In other words, the back plates 123 are adapted to engage the user so as to position his/her spine along the gap 126. Similarly, the lumbar plate 125 can include lateral lumbar wings 128 adapted to engage the user's lower back mainly on either side of his/her spine. In this embodiment, the lateral lumbar wings 128 are connected to each other via a bridge member 130 to improve structural stability of the lumber plate 125. However, it should be noted that that lateral lumbar wings 128 can be independent from one another in order to avoid structural components overlapping the user's spine, for example. This configuration of the back plate 123 and the lumbar plate 125 improves comfort of the user, allowing for an increased flexibility and additional freedom of movement.

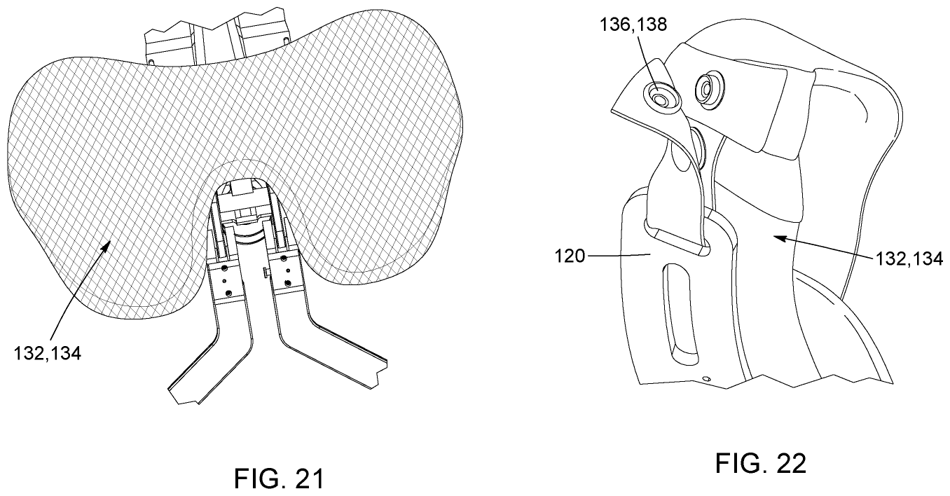

As seen in FIGS. 21 and 22, some portions of the garment 110 can include a protective layer 132 configured to improve comfort of the user. In some embodiments, the protective layer 132 can include textile padding 134 removably coupled to the support plates 120 to facilitate maintenance and upkeep thereof. For example, the textile padding 134 can be attached to respective portions of the garment via Velcro®, clips, loops of fabrics, buttons or any other suitable means or combination thereof. Alternatively, and as previously stated, the support plates 120 can correspond to inserts configured to be inserted within the textile padding 134

With reference to FIGS. 2 to 6, the exoskeleton mechanism 200 is a rigid mechanism comprising a series of rotational and translational joints adapted to allow freedom of movement of the subject's 5 hips and lower back. In this embodiment, the exoskeleton mechanism 200 includes an upper section 202 coupled between the torso anchor 152 and the waist anchor 154, and a lower section 204 coupled between the waist anchor 152 and the thigh anchors 156. The upper and lower sections 202, 204 are adapted to cooperate to receive and/or redirect forces from and to the user for assisting in performing various tasks. As will be described further below, upon movement of the user, the exoskeleton mechanism 200 is adapted to support the user's torso by leaning on the thighs and the lumbar region.

In some embodiments, the exoskeleton mechanism is configured to store energy during certain movements (e.g., flexion of the hips), and redirect the energy (e.g., to the torso) during subsequent extension movements, thereby providing assistance to perform the movement. The assistance provided to the user is accomplished via a cooperation between systems of the exoskeleton mechanism 200. In this embodiment, the exoskeleton mechanism 200 includes an actuator system 210 configured to store and release energy generated during movement of the user in order to assist the user in performing said movement and/or a corresponding task, and an adaptative system 250 configured to dynamically adjust the relative distance between the different parts of the exoskeleton during movement (e.g., flexion, extension, etc.) to assist the user in performing unhindered movements.

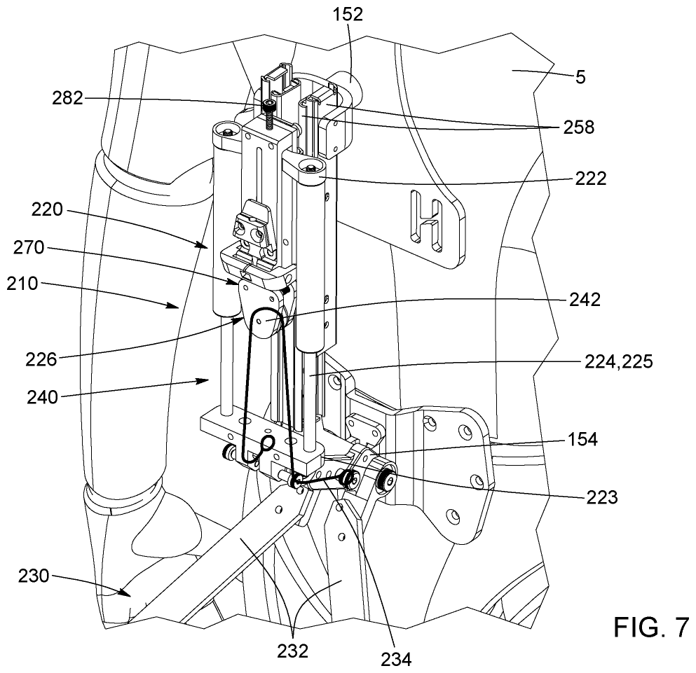

Now referring to FIGS. 7 to 10, the actuator system 210 includes a spring-loaded assembly 220 operable to generate a force, and further includes one or more actuator links 230 operatively coupled between the user 5 (e.g., via the garment and exoskeleton interface) and the spring-loaded assembly 220. The actuator links 230 are configured to operate the spring-loaded assembly 220 upon movements performed by the user. In this embodiment, the spring-loaded assembly 220 is positioned in the upper section 202 of the exoskeleton mechanism 200 (e.g., between the torso and the waist attachments 113, 115), and the actuator links 230 are positioned in the lower section 204 (e.g., between the waist and the thigh attachments 113, 117). However, it is appreciated that other configurations are possible, such as inversing the position of the spring-loaded assembly and the actuator links, or positioning both the spring-loaded assembly and the actuator links in the same section of the exoskeleton, for example.

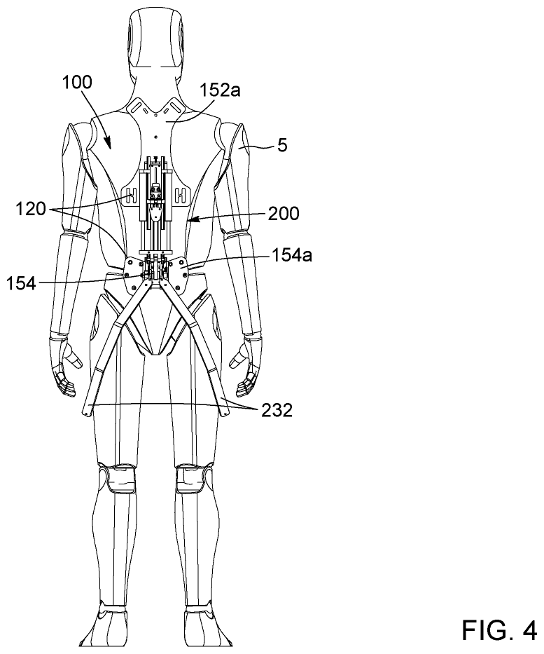

As seen in FIGS. 4 and 7 to 9, the actuator links 230 can include a pair of rigid actuator arms 232 respectively extending between the waist anchor 154 and one of the thigh anchors 156. It is thus noted that each actuator arm 232 is pivotally coupled to the pivot joint of the waist anchor 154 at a first end thereof, and is coupled to a corresponding one of the thigh anchors 156 at a second end thereof. Therefore, during movement of the user 5, the actuator arms 232 are adapted to rotate about the pivot axis defined by the pivot joint. As mentioned, the actuator arms 232 are operatively coupled to the spring-loaded assembly 220 such that movement of the user engages the actuator arms 232 in rotation (e.g., about the pivot axis) and actuates the spring-loaded assembly 220. More specifically, in this embodiment, each actuator arm 232 includes an extension or connection arm 234 extending therefrom and defining a connection point 235. The actuator system 210 further includes a spring actuator configured to actuate operation of the spring-loaded assembly 220 to generate the force which can be used to assist the user in performing various movements. In this embodiment, the spring actuator includes a cable 236 extending between the spring-loaded assembly 220 and the connection point 235 of the connection arm 234. Therefore, rotation of the actuator arms 232 pulls on the cable 236, which in turn actuates (e.g., pulls) the spring-loaded assembly 220 for operation thereof.

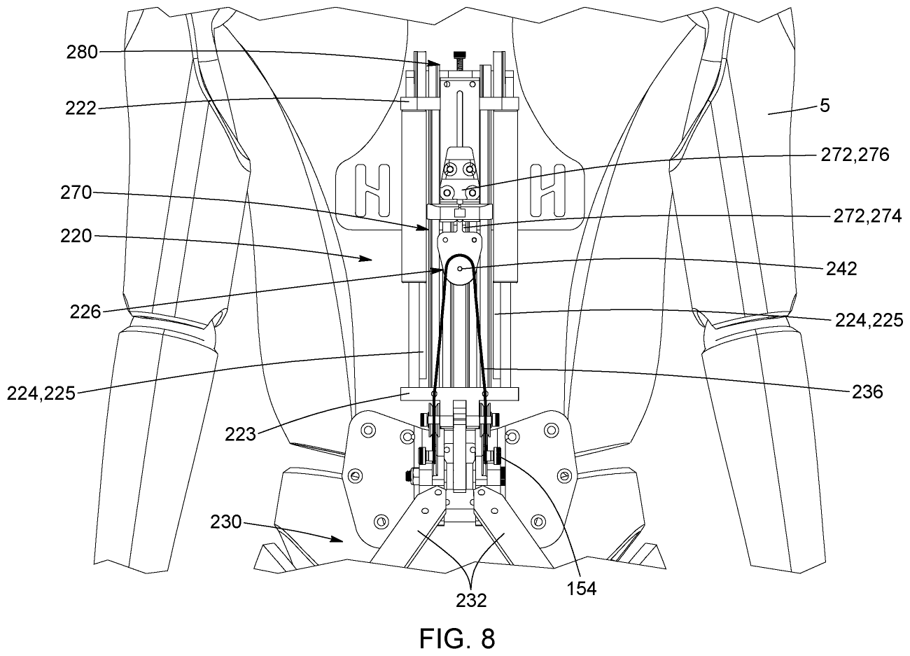

Referring to FIGS. 7 to 10, the spring-loaded assembly 220 includes a casing 222 coupled between the torso anchor 152 and the waist anchor 154. The spring-loaded assembly 220 also includes at least one resilient element 224 provided within the casing and a coupling point 226 connectable to the casing 222. The coupling point 226 is adapted to be coupled to the actuator arms 232 via the cable 236 such that, upon the user performing a hip flexion, for example, the coupling point 226 is pulled downwardly, thereby simultaneously engaging the resilient element 224. The resilient element 224 can include one or more springs, pistons, gas cylinders or any other suitable device adapted to generate a force when deformed (e.g., compressed) or deflected. As illustrated in FIGS. 7 and 8, in this embodiment, the resilient element 224 includes a pair of pistons 225 provided opposite each other relative to the coupling point 226.

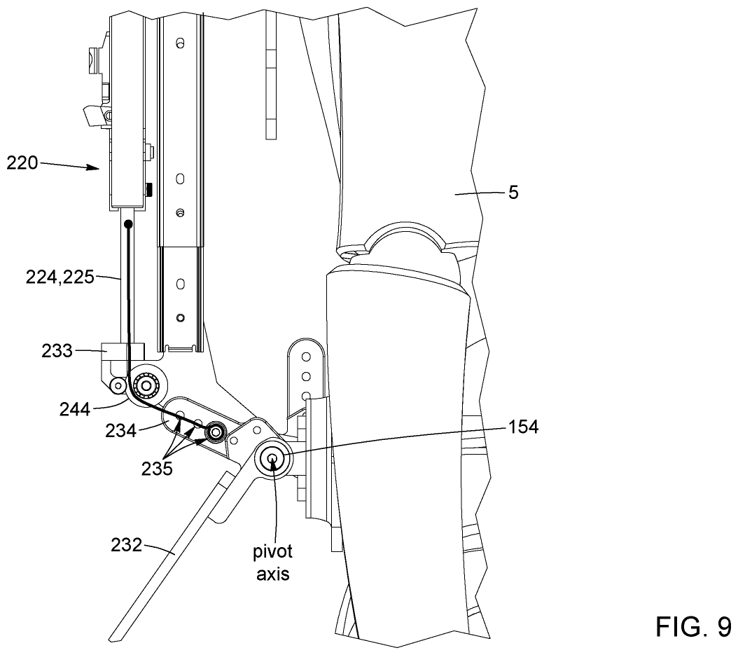

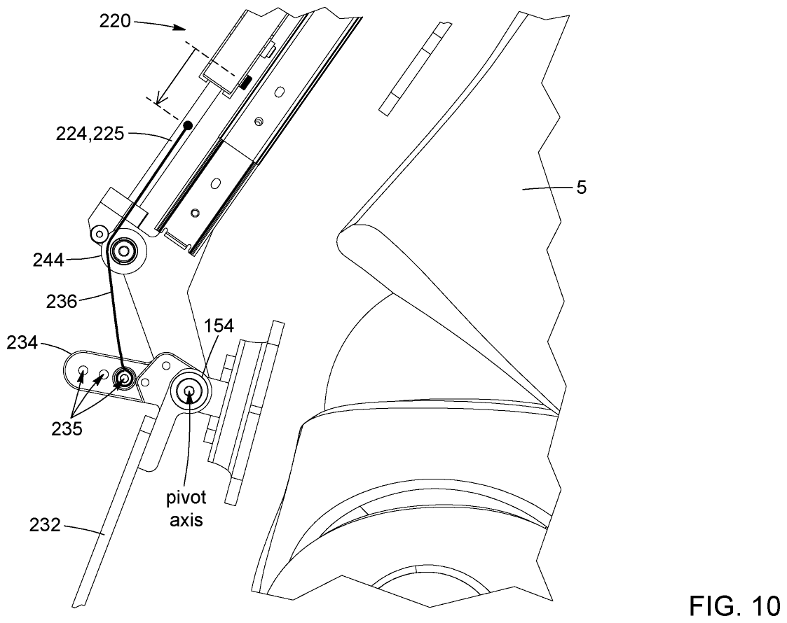

With further reference to FIGS. 9 and 10, upon movement of the user from a standing position (FIG. 9) to a hip-flexed position (FIG. 10), at least one of the casing 222 and the actuator arms 232 rotate about the pivot axis of the waist attachment 154, which pulls on the cable 236 and engages (e.g., compresses) the pistons 225 against a bottom surface 223 of the casing 222. Upon engagement, the pistons 225 generate a force in order to extend back to their initial configuration. This force is transmitted, via the cable 236, to the connection arm 234. The cable, which is now under tension, generates a torque about the pivot joint of the waist anchor 154 (e.g., about the pivot axis). In some embodiments, the connection arm 234 is adapted to define a plurality of connection points 235 to which the cable can be connected. As such, it is appreciated that the amount of torque generated can be adjusted by changing the position of the cable along the connection arm 234, which adjusts a length of the lever arm in the calculations of the torque. The generated torque (or moment) is transmitted to the user 5 via the various interface anchors to support the upper body of the user 5, thereby assisting in any task being performed.

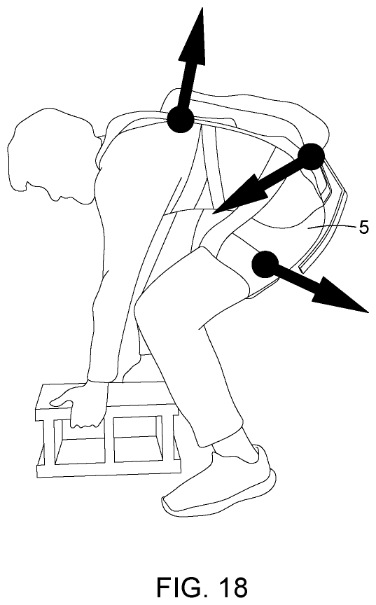

As seen in FIG. 18, and as previously mentioned, the torque generated enables the exoskeleton to “lean” on the waist and the thighs of the user to support the torso/upper body of the user. The garment portions of the exoskeleton can be positioned in locations of the body enabling the generation and transmission of generally perpendicular forces for assisting the user in performing movements and tasks. The lower section can pull on the corresponding garment portion (e.g., the thigh attachments) which generates an outwardly oriented force. In this embodiment, the generated force is generally perpendicular relative to the garment portion, and is thus generally perpendicular to the corresponding body part of the user. For example, in this embodiment, the lower section is adapted to generate a substantially perpendicular force relative to the thighs of the user. This generated force is stored by the exoskeleton mechanism, which allows the exoskeleton to “lean” on the lower body of the user, such as on the waist and thighs of the user.

The exoskeleton mechanism is configured to transfer the stored forces to the upper body. In this embodiment, the stored forces are transferred to the upper section, such as to the torso attachment of the garment, which is coupled to the torso of the user. As such, the transferred forces “pull” on the upper body of the user, as depicted in FIG. 18. The transferred forces are substantially perpendicular to the upper section, and thus perpendicular to the upper body of the user. It is noted that the exoskeleton is configured to generate and transfer forces perpendicularly relative to the body of the user. This configuration increases the comfort of wearing, using and working with the exoskeleton. It is appreciated that increased comfort can improve or facilitate usage of the exoskeleton, which can, in turn, improve the efficiency of the user in performing the tasks at hand.

Referring back to FIGS. 7 and 8, in this embodiment, the coupling point 226 is connected to both actuator arms 232 by a single cable 236 at any given time. As such, the actuator system 210 can include a distributor mechanism 240 configured to distribute the force generated by the pistons evenly between the actuator arms. In other words, the cable is under tension and generates the same pulling force at either ends thereof (e.g., on the connection arms 234). In this embodiment, the distributor mechanism 240 includes a central pulley 242 through which the cable 236 extends such that the same amount of cable tension is transmitted to each connection arm 234. Additional pulleys 244 (seen in FIGS. 9 and 10) can be provided to facilitate running the cable 236 from one connection arm 234 to the other and passing through the central pulley 242. It should be understood that, in this embodiment, the coupling point 226 generally corresponds to the central pulley 242 of the distributor mechanism 240, although other configurations are possible.

In this embodiment, the distributor mechanism 240 is adapted to assist in enabling asymmetrical movements made by the user, such as lunges, or simply walking, where one leg is put in front of the other, for example. The distributor mechanism 240 is configured to distribute the forces generated by the spring-loaded assembly evenly between the actuator arms, and therefore between the thighs of the user. Therefore, it is noted that, upon flexing one leg more than the other, for example, while kneeling on one knee, both thighs sustain substantially the same amount of force. The user can thus more easily maintain their balance and move unrestrained and unbothered by the exoskeleton as the distributor mechanism 240 operates to dynamically distribute the forces to both thighs. The distributor mechanism 240 can also increase an overall comfort level of the user, who can move in a more natural manner.

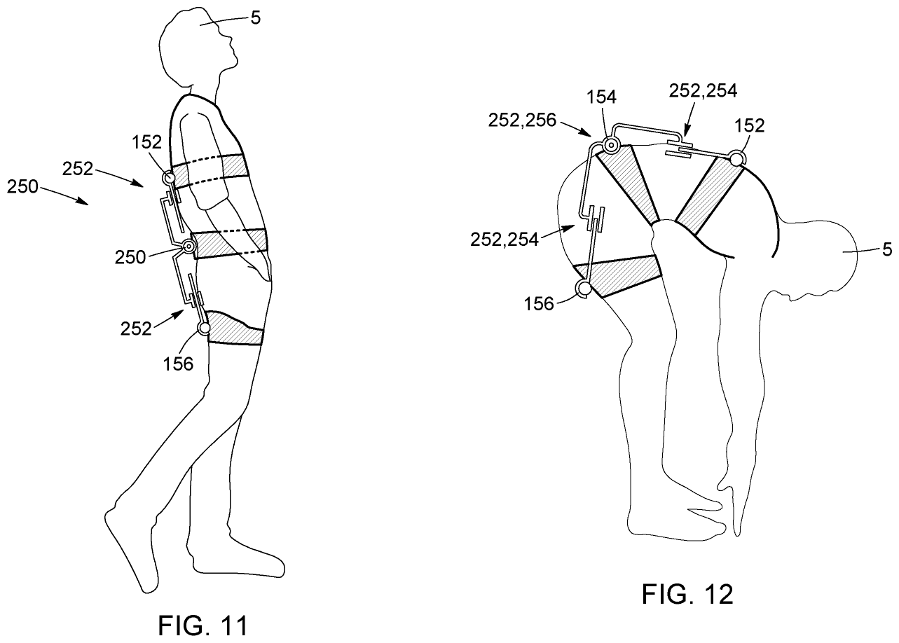

With reference to FIGS. 11 to 13D, in addition to FIGS. 2 to 6, the adaptative system 250 will now be described in further detail. In some embodiments, the anchors of the exoskeleton interface are not aligned with the joints of the human body. As such, the adaptative system 250 is configured to compensate for this misalignment by enabling adjustments of the relative distances between different parts of the exoskeleton during movement of the user. In this embodiment, the adaptative system 250 includes adaptative links 252 configured to dynamically adjust relative distances at least between the interface anchors during movement of the user. This configuration enables the exoskeleton to be positioned along the user's back to free up the front and sides, which can allow for the use of accessories, such as tool belts, among others. The adaptative system 250 also allows the exoskeleton to be used by a wide range of morphologies (i.e., body types). More specifically, the harness 111 can be worn by a wide range of body types and the exoskeleton mechanism 200 will adjust itself to the size of the user by enabling relative movement between two or more of the interface anchors.

The adaptative links are configured to enable the subject 5 wearing the exoskeleton 100 to perform a plurality of movements such as lateral hip flexion and extension, hip abduction and adduction, a combination of lateral hip flexion and extension and frontal hip flexion and extension, as well as trunk rotations. For example, when performing a hip flexion (i.e., moving from a standing position (FIG. 11) to a flexed position (FIG. 12)) the distances between the torso anchor 152, the waist anchor 154 and the thigh anchors 156 change. The adaptative links 252 are configured to adjust and adapt to these changes dynamically (e.g., in real-time, during movement of the user). The subject 5 may move freely and with little to no resistance from components of the exoskeleton when performing various movements, such as those mentioned, among others.

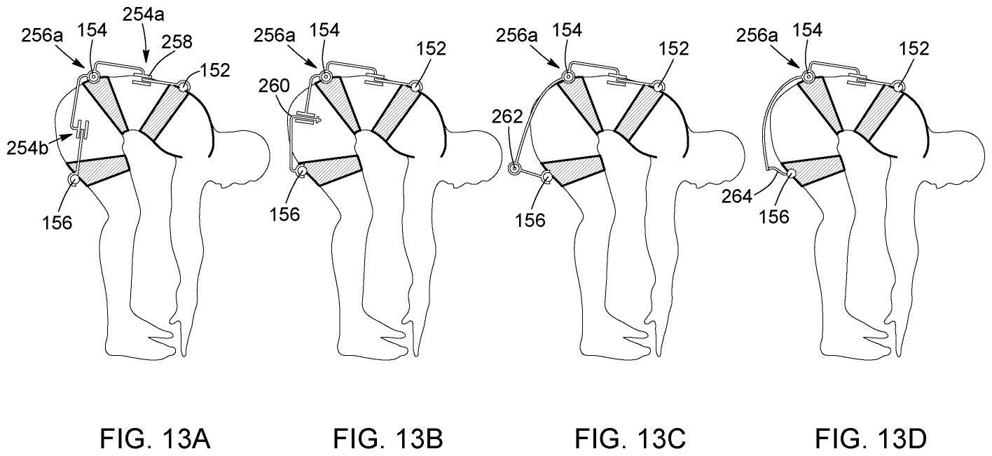

In this embodiment, the adaptative links 252 include a combination of sliding links 254 and pivot links 256. It is appreciated that a sliding link 254 is configured to adjust a distance between two points, and a pivot link 256 is configured to adjust an angle between two segments or parts. More specifically, and as seen in FIGS. 13A to 13D, a first sliding link 254a can be provided between the torso anchor 152 and the waist anchor 154, and a second sliding link 254b can be provided between the waist anchor 154 and the thigh anchors 156. It is appreciated that due to users typically having two thighs, the adaptative system includes a pair of second sliding links 254b extending between the waist anchor 154 and respective thigh anchors 156. In this embodiment, each one of the pair of second sliding links 254b is provided along a corresponding one of the actuator arms 232 of the actuator system. Therefore, it is noted that the distance between each thigh anchors 156 and the waist anchor 154 can be individually and independently adjusted. This configuration further improves the range of motion of the user by allowing asymmetric movements, such as side lunges, one-knee kneeling or simply walking, among other possible movements.

As seen in FIGS. 13A to 13D, the pivot links 256 include a first pivot link 256a provided at the waist attachment 115 and configured to enable adjustment of the angle between the upper section 202 and the lower section 204 of the exoskeleton mechanism. In this embodiment, the first pivot link 256a corresponds to the pivot joint of the waist attachment, as previously described, although other configurations are possible, such as providing a separate or second pivot joint, for example.

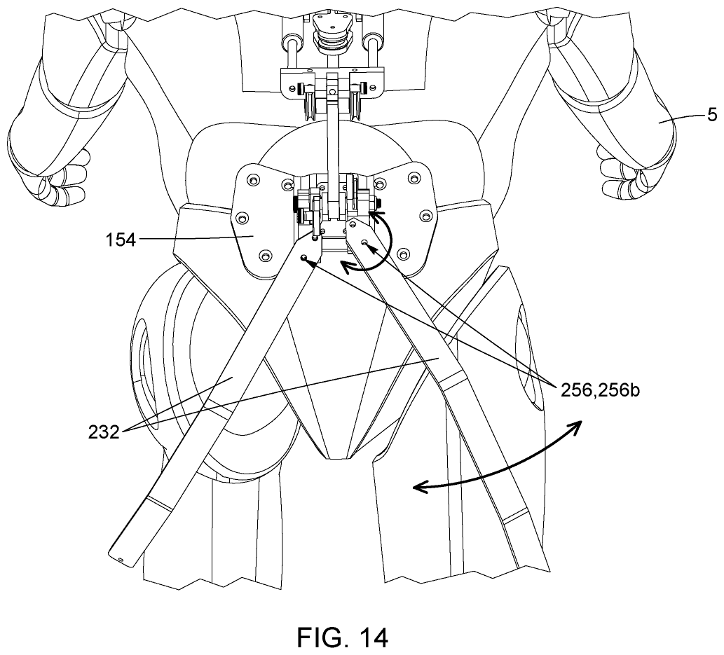

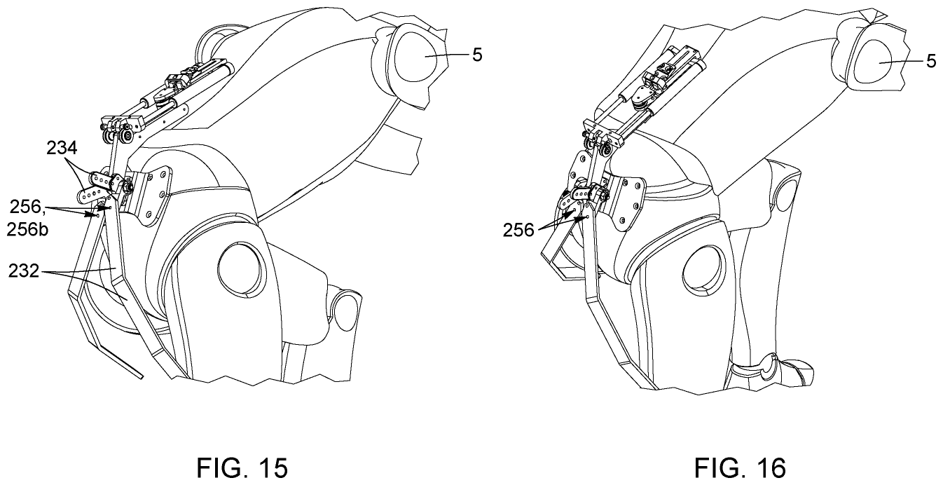

With reference to FIGS. 14 to 16, the pivot links 256 can include second pivot links 256b configured to enable adjustment of the angle between the actuator arms 232 and the waist attachment and/or the angle defined between both actuator arms 232. More specifically, in this embodiment, the second pivot links 256 enable hip adduction and hip abduction movements (e.g., raising/lowering the leg sideways, spreading/joining the legs, etc.). It is appreciated that the actuator arms 232 include respective second pivot links 256b, enabling independent movement of each actuator arm 232.

The sliding links 254 (e.g., the first and second sliding links 254a, 254b) can include any suitable components, such as typical sliding members 258 (or “sliders”) slidably coupled to one another between the anchors, as seen in FIG. 13A. In some embodiments, and as illustrated in FIG. 7, the first sliding link 254a can cooperate with the spring-loaded assembly 200 to enable relative movement between the torso and waist anchors 152, 154, and maintain the spring-loaded assembly 200 in a desired position. For instance, the first sliding link 254a can enable maintaining the spring-loaded assembly 220 in general alignment with the user's lower back, among other possibilities.

In this embodiment, the first sliding link 254a can include a pair of sliding members 258, with one sliding member 258 being coupled to the torso anchor 152, and the other sliding member 258 (e.g., a complementary sliding member 258) being coupled to the waist anchor. The sliding members 258 are configured to slide relative to one another, thus enabling relative movement between the torso and waist anchors. In some embodiments, the sliding members 258 enable adjusting the overall length of the exoskeleton mechanism 200 by sliding apart during certain movements, for example, when bending forward, and sliding back together during the opposite movement. It should thus be understood that the sliding members 258 are operable between an extended configuration (e.g., during some movements, such as hip flexion), and a retracted configuration (e.g., during other movements, such as hip extensions). In some embodiments, when the user is at rest, such as in a standing position, the sliding members 258 are configured to be in the retracted configuration, although other configurations are possible. The sliding links 254 can alternatively, or additionally include a double-pivot link along a frontal axis 260 (i.e., an axis extending front to back) or along a sagittal axis 262 (i.e., an axis extending from left to right), as seen in FIGS. 13B and 13C, respectively.

In yet another possible embodiment, the sliding link 254 can include a textile link 264, such as a strap, rope or cord, which is adapted to provide freedom of motion to the user for a length of the textile link 264, as seen in FIG. 13D. In other words, the textile link 264 enables at least two parts to be linked, with at least one of those two parts having full freedom of motion (e.g., 6 degrees of freedom) relative to the other. However, it is noted that the freedom of motion is possible within a predetermined range, which, in this embodiment, corresponds to a length of the textile link 264. In FIG. 13D, the textile link 264 extends between a bottom end of the actuator arm 232 and the thigh anchor 156, such that the user benefits from complete freedom of motion as long as the textile link 264 remains flexible (loose, lax, slack), and is not under tension. However, other configurations are possible, such as providing a pair of sliding members along a length of the actuator arms 232 to enable adjusting their lengths during movements made by the user. Examples of the sliding links can be found in Applicant's own publication No. WO2022254367A1, which is hereby incorporated in its entirety by reference.

In some embodiments, and with reference to FIGS. 7, 8 and 17, the exoskeleton mechanism 200 can include an activation mechanism 270 configured to allow selective operation of the actuator system 210. More specifically, the activation mechanism 270 is operable between an engaged (or “on”) mode, and a disengaged (or “off”) mode. In some embodiments, the activation mechanism 270 includes a pair of complementary connectors 272 configured to be connected to one another when desired. For example, the complementary connectors 272 can include male-female connectors, clip-or buckle-type connectors, etc. In this embodiment, the complementary connectors 272 include a first connector 274 positioned on the coupling point 226 (e.g., on the central pulley 242) and a second connector 276 located on or coupled to the casing 222 of the of the spring-loaded assembly 220. Upon disconnecting the first and second connectors 274, 276 from one another, the link between the actuator arms and the pistons of the spring-loaded assembly is correspondingly broken. In other words, a downward force on the central pulley 242, via the cable, no longer compresses the pistons 225, which therefore no longer generate the corresponding forces. It should thus be understood that, upon connection of the first and second connectors 274, 276, the exoskeleton mechanism 200 can operate as intended.

In some embodiments, the activation mechanism 270 can include an activation lever 278 coupled to any one of the first connector 274 and the second connector 276 for selectively operating the activation mechanism 270 between the on and off modes. The activation lever 278 can be manually operated (e.g., pushed, pulled, etc.) to operate the activation mechanism 270 in the desired mode. The activation lever 278 can extend from a portion of the corresponding connector to facilitate manipulation thereof. In some embodiments, the activation lever 278 is linked to a switch (not shown) adapted to be worn on a front side of the exoskeleton to facilitate access by the user. For example, the switch can be provided on a strap of the harness, or any other suitable location which can be substantially easy to access. The switch can be linked to the activation lever via a wire or chain such that operating the switch correspondingly displaces the connectors in the desired mode (i.e., engaged or disengaged). It is thus noted that the switch can be toolessly operated by the user to change the operational mode of the exoskeleton. Moreover, in this embodiment, the switch is toolessly operated on a front side of the user in order to actuate and displace connectors 274, 276 provided on a back side of the user.

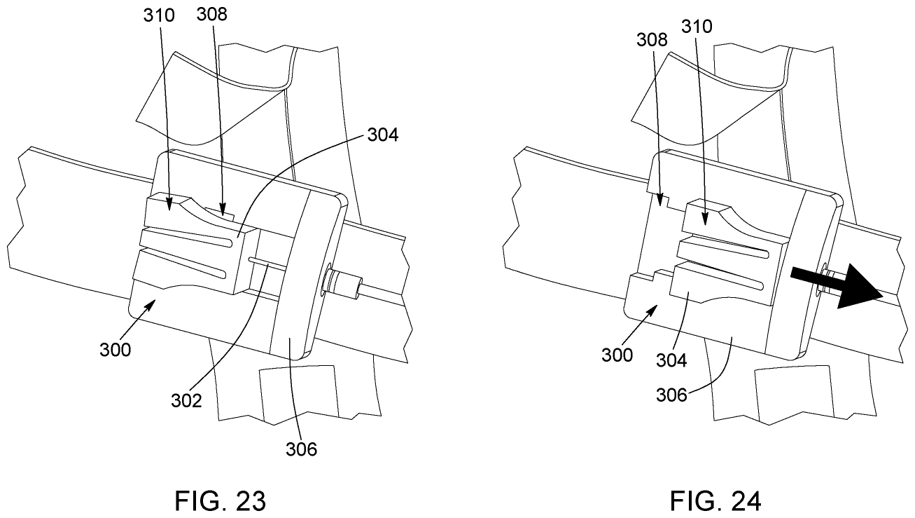

With reference to FIGS. 23 to 26, an exemplary switch 300 is illustrated. The switch 300 is mechanically coupled to the activation lever via the wire 302 such that displacement of the switch 300 correspondingly displaces the activation lever and operates the actuation mechanism. In this embodiment, the switch 300 includes a switch toggler 304 operatively coupled to a switch casing 306. The switch casing 306 can include grooves and/or recesses 308 defining predetermined positions for the switch toggler 304 to be in. For example, the switch toggler 304 can include a resilient brace 310 shaped and sized to engage the recesses 308 for locking the switch toggler in pace. The resilient brace 310 can then be operated to disengage the corresponding recess and enable movement of the switch toggler 304 along the switch casing.

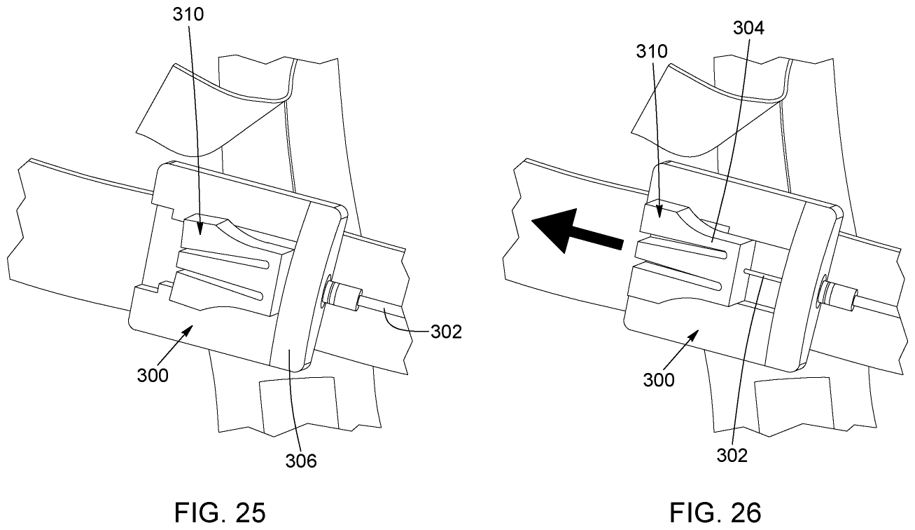

For example, the switch toggler 304 can be positioned in a first one of the predetermined positions (FIG. 23), which can correspond to operation of the activation mechanism in one of the on or off modes. The resilient brace 310 can then be operated (e.g., squeezed) to disengage the recess of the first position to enable movement of the switch toggler 304 (FIG. 24). The switch toggler 304 can then be moved (e.g., slid) along the switch casing 306 to a second one of the predetermined positions (FIG. 25). The resilient brace 310 is configured, by its resilient nature, to autonomously engage the recess aligned therewith, thereby locking the switch toggler 304 in place. The switch toggler can therefore be pushed into the second position (FIG. 26), which corresponds to operation of the activation mechanism in the other one of the on and off modes.

Referring back to FIGS. 7, 8 and 17, in some embodiments, the first connector 274 is coupled to the central pulley 242 of the distributor mechanism 240. As previously described, the spring-loaded assembly 220 is operable by tensioning the cable 236 (e.g., as the user performs certain movements) which pulls on the central pulley 242, which in turn actuates (e.g., pulls) the spring-loaded assembly 220 by compressing the pistons 225. It is appreciated that, by disconnecting the central pulley 242 from the spring-loaded assembly 220, the exoskeleton is mostly inoperative as no forces are being generated, applied and/or transmitted. In other words, in this embodiment, the distributor mechanism 240 enables the use of a discrete and singular activation mechanism 270 by providing the singular coupling point 226 (e.g., the central pulley 242) which connects with the spring-loaded assembly 220. However, it is appreciated that alternate embodiments are possible, such as providing an activation mechanism 270 which connects additional parts of the exoskeleton together to enable operation thereof.

The exoskeleton mechanism 200 can further include an offset mechanism 280 configured and operable to enable adjustment of an engagement angle of the exoskeleton mechanism 200. It should be noted that, as used herein, the expression “engagement angle” refers to the range of motion allowed prior to engaging the spring-loaded assembly 220, and therefore refers to the range of motion allowed prior to putting the cable 236 under tension. In other words, the offset mechanism 280 is operable to adjust the angle at which the exoskeleton starts to provide support. In this embodiment, the exoskeleton can initially be put on a user, and the offset mechanism 280 can then be operated, as desired. For instance, the offset mechanism 280 can be operated to reduce the range of motion required for engaging the spring-loaded assembly 220 such that the exoskeleton provides support to the user as soon as movement is initiated (e.g., hip flexion). Inversely, the offset mechanism 280 can be operated to increase the range of motion allowed prior the providing support to the user, providing the user a greater range of “unsupported” motion.

In this embodiment, the offset mechanism 280 is configured to adjust the position of the coupling point 226 relative to the casing 222 of the spring-loaded assembly 220. More specifically, in this embodiment, operating the offset mechanism 280 moves the coupling point 226 along an axis parallel to the pistons 225. It is therefore appreciated that operating the offset mechanism 280 adjusts the position of the coupling point 226 generally vertically along the back of the user wearing the exoskeleton. While the position of the coupling point 226 is adjusted, the length of the cable 236 remains substantially unchanged. Thus, the range of motion required to put the cable under tension is correspondingly adjusted by operating the offset mechanism 280. For instance, lowering the coupling point 226 reduces the distance between the central pulley 242 and the connector arms 234 which correspondingly increases the range of motion required to put the cable under tension in order to initiate operation of the spring-loaded assembly. In a similar fashion, raising the coupling point 226 increases the distance between the central pulley 242 and the connector arms 234, thereby reducing the range of motion required by the user to put the cable under tension.

In some embodiments, the offset mechanism 280 can therefore be adapted to define a predetermined and/or desired range of motion for operation of the spring-loaded assembly 220. The predetermined range of motion can correspond to a forward angular motion of the user (e.g., bending forward). The angle at which the user bends forward can therefore be adjusted via operation of the offset mechanism. As will be explained further, the offset mechanism 280 can define an initial tension in the cable. For instance, by raising the coupling point, the cable can be pre-tensioned while the user is in a standing and/or idle position, for example. In other words, in some embodiments, the offset mechanism 280 can be operated to put the cable under tension while the user is in a standing position, thereby enabling operation of the spring-loaded assembly as soon as movement is initiated. In such embodiments, the required forward angular motion is therefore substantially 0 degrees, since the cable is pre-tensioned. In other instances, the offset mechanism 280 can be operated to adjust the required forward angular motion to about 90 degrees. In the present embodiment, the offset mechanism 280 can be operated to adjust the forward angular motion required to actuate operation of the spring-loaded assembly to between about 0 degrees (e.g., pre-tensioned cable) and about 60 degrees, although other configurations are possible.

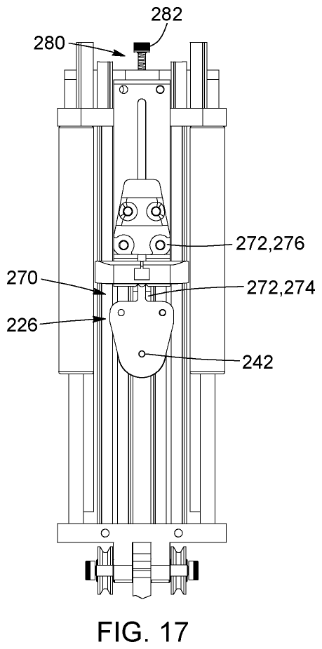

In this embodiment, the offset mechanism 280 is adapted to be operated by hand. In other words, the offset mechanism 280 can be toolessly operated in order to adjust the position of the coupling point 226. The offset mechanism 280 can include an offset actuator 281 configured to be operated by hand in order to actuate the offset mechanism 280 (e.g., adjust the initial tension of the cable and/or adjust the required angular motion for operation of the spring-loaded assembly). As seen in FIG. 17, the offset actuator 281 can include a set screw 282 coupled, either directly or indirectly, to the coupling point 226. The set screw 282 being selectively operable to raise and lower the coupling point 226, and is therefore configured to increase or lessen the tension in the cable, as desired. In this embodiment, the set screw 282 is coupled to at least one of the second connector 276 and the casing 222 of the of the spring-loaded assembly 220. As such, it is appreciated that the second connector 276 can be displaced upon operation of the offset mechanism 280 (e.g., of the set screw 282), and that the coupling point 226 can be simultaneously adjusted when the first connector 274 is engaged with the second connector 276. In other words, the offset mechanism 280 can be unoperational prior to operating the activation mechanism 270 (e.g., prior to connecting the first and second connectors 274, 276).

In this embodiment, the set screw 282 includes a head portion 284 shaped and sized to facilitate grasping thereof, by hand, in order to rotate the set screw 282 and operate the offset mechanism 280. The head portion can be of any suitable shape, size and configuration. In this embodiment, the head portion 284 includes a ridged outer perimeter to facilitate manipulation thereof and increase ease-of-use of the offset mechanism 280 without tools (e.g., by hand). Moreover, the head portion 284 can be affixed to a top end of the set screw 282 and adapted to move up and down as the set screw is correspondingly screwed and unscrewed. However, in this embodiment, the head portion 284 includes a hole extending therethrough and enabling the set screw to extend through the hole during adjustment of the position of the coupling point. This configuration further allows the head portion 284 to remain substantially static relative to the other components of the exoskeleton, while urging the set screw (and associated parts) up and down upon rotation of the head portion.

It should be noted that the set screw 282 enables continuous adjustment of the position of the coupling point 226. Theoretically, the set screw 282 allows for an infinite number of possible positions for the coupling point 226. In this embodiment, the coupling point can be positioned at a lowest position, a highest position and at any position between the lowest and highest positions. It should be noted that the lowest position of the coupling point defines the greatest required forward angular motion for initiating operation of the spring-loaded assembly, while the highest position of the coupling point defines the smallest required forward angular motion (e.g., 0 degrees), corresponding to pre-tensioning the cable, as described above. The offset actuator can alternatively include any other suitable mechanism for operating the offset mechanism and adjust the position of the coupling point. For example, the offset actuator can be operable to adjust the coupling point at a plurality of predetermined positions, such as 3, 4, or 5 different predetermined positions.

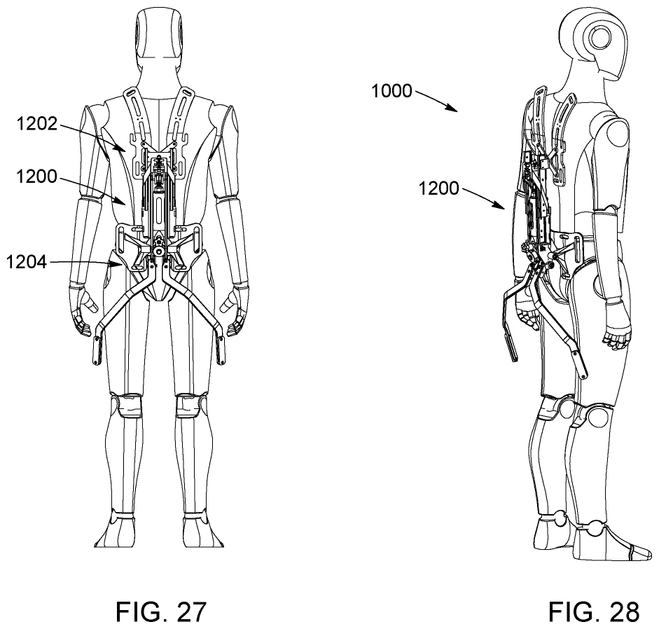

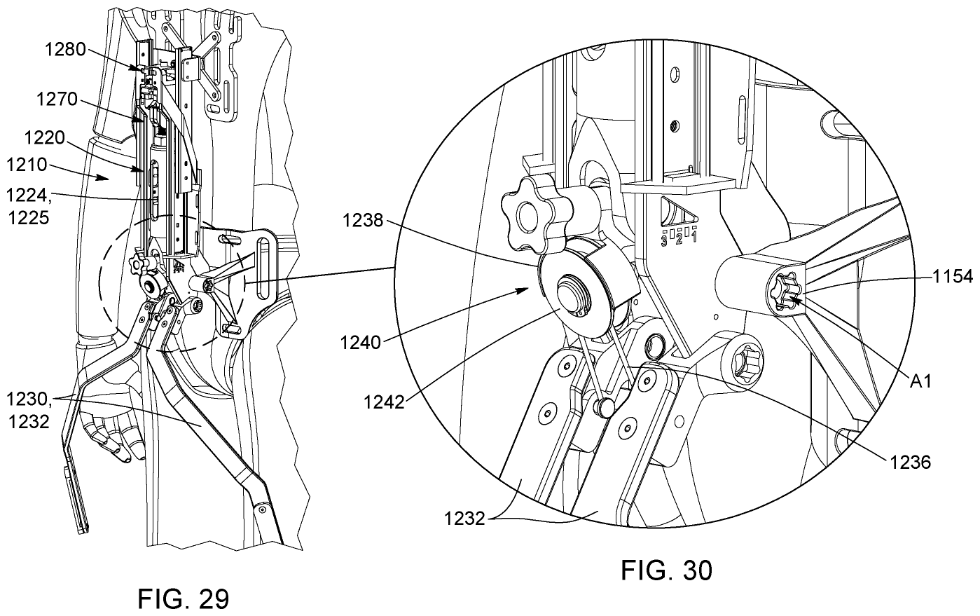

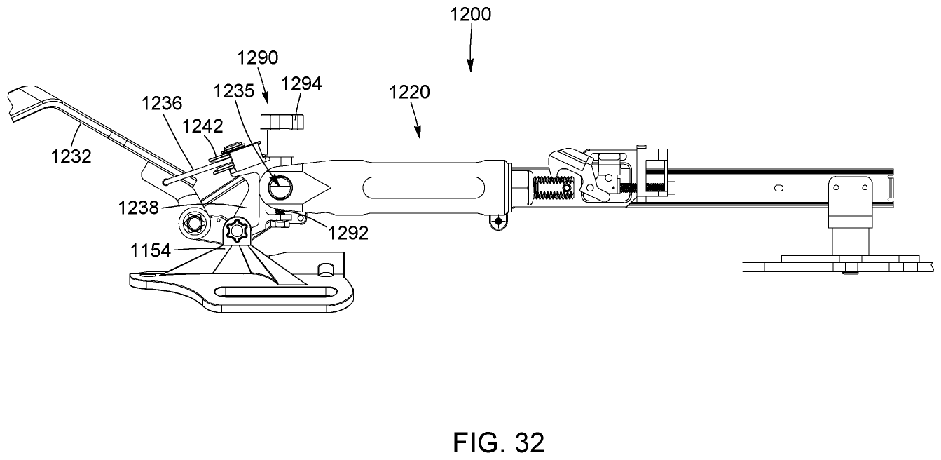

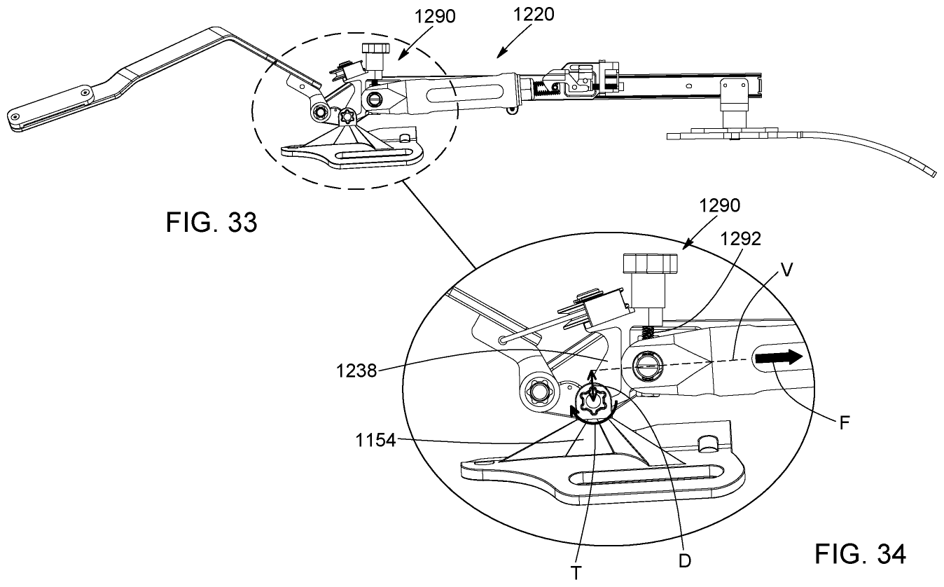

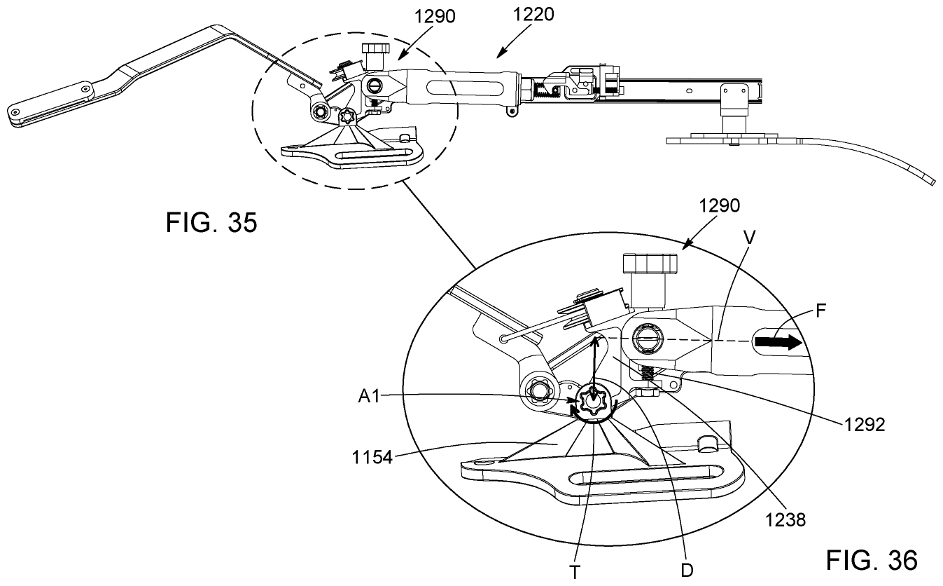

Now referring to FIGS. 27 to 41, another implementation of the exoskeleton 1000 is shown. The exoskeleton 1000 functions in a similar fashion as the exoskeleton 100 described above, in that it is configured to store energy during certain movements (e.g., flexion of the hips), and redirect the energy (e.g., to the torso) during subsequent extension movements, thereby providing assistance to perform the movement. The assistance provided to the user is accomplished via a cooperation between systems of the exoskeleton mechanism 1200. In this embodiment, the exoskeleton mechanism 1200 includes an actuator system 1210 configured to store and release energy generated during movement of the user in order to assist the user in performing said movement and/or a corresponding task, and an adaptative system 1250 configured to dynamically adjust the relative distance between the different parts of the exoskeleton during movement (e.g., flexion, extension, etc.) to assist the user in performing unhindered movements.

With reference to FIGS. 27 to 30, the actuator system 1210 includes actuator links 1230 operatively coupled between the user (e.g., via the garment and exoskeleton interface) and the spring-loaded assembly 1220. The actuator links 1230 are configured to operate the spring-loaded assembly 1220 upon movements performed by the user. The actuator links 1230 can include a pair of rigid actuator arms 1232 pivotally coupled to the pivot joint A1 of the waist anchor at a first end thereof, and is coupled to a corresponding one of the thigh anchors at a second end thereof. Therefore, during movement of the user, the actuator arms 1232 are adapted to rotate about the pivot axis defined by the pivot joint. In some embodiments, each actuator arm 1232 can be coupled to the waist anchor individually, for example, in a manner allowing rotation thereof about respective pivot axes. Both pivot axes (of each actuator arm) can be aligned with one another or misaligned. Moreover, the pivot axes can be parallel or transverse relative to each other.

As mentioned, the actuator arms 1232 are operatively coupled to the spring-loaded assembly 1220 such that movement of the user engages the actuator arms 1232 in rotation (e.g., about the pivot axis) and actuates the spring-loaded assembly 1220. In this embodiment, the actuator system 1210 includes a spring actuator 1211 configured to actuate operation of the spring-loaded assembly 1220 to generate the force which can be used to assist the user in performing various movements. The spring actuator includes a coupling joint 1238 pivotally coupled to the waist anchor 1154 and a cable 1236 extending between the coupling joint 1238 and the actuator arms 1232. Therefore, rotation of the actuator arms 1232 pulls on the cable 1236, which pulls the coupling joint 1238 and pivots the coupling joint 1238 relative to the waist anchor (about the waist pivot axis (A1). The coupling joint 1238 is connected to the spring-loaded assembly 1220 such that pivotal movement of the coupling joint 1238 about the waist pivot axis actuates (e.g., pulls) the spring-loaded assembly 1220 for operation thereof. In this embodiment, the resilient element 1224 of the spring-loaded assembly 1220 includes one or more compression springs 1225, such as a high force compression spring (e.g., die spring). It is appreciated that these types of springs can be designed to consistently generate a predetermined force at a given compression.

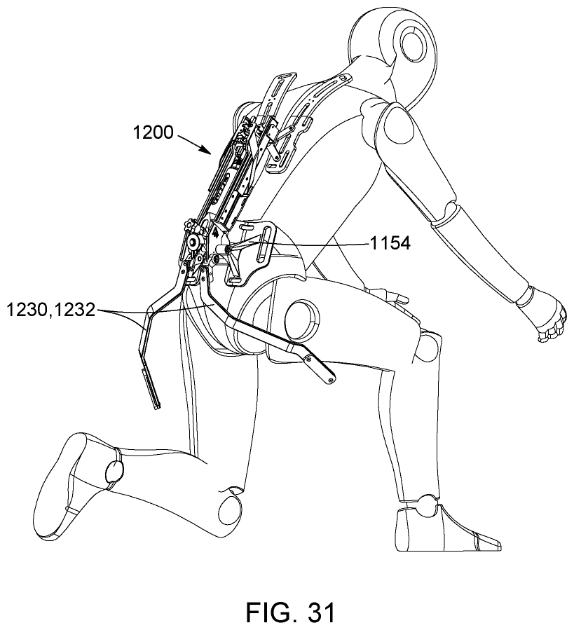

Upon movement of the user from a standing position (FIG. 28) to a kneeling position (FIG. 31), for instance, at least one of the actuator arms 1232 rotates about the pivot axis of the waist anchor 1154, which pulls on the cable 1236 and engages (e.g., compresses) the compression spring 1225. The compression spring 1225 therefore generates a force in an attempt to extend back to its initial configuration/length. With reference to FIG. 32, the generated force is transmitted, via the cable 1236, to the actuator arms 1232, which lean on the user's thighs through their connection with the user via the garment. The force generated by the compression spring 1225, which is at least partially compressed, generates a torque about the pivot axis A1, to which the coupling joint 1238 and the actuator arms are connected. This torque can then be transferred to the upper section of the exoskeleton, via the structure of the exoskeleton mechanism 1200, to the torso attachment of the garment for assisting the user in certain movements.

In some embodiments, the amount of torque generated can be adjusted by changing the length of the lever arm defined and used in the calculations of the torque. As seen in FIGS. 32 to 36, the actuator system 1210 can include a force adjuster 1290 selectively operable to adjust the torque generated by the exoskeleton mechanism 1200 during movement of the user. In this embodiment, the force adjuster 1290 is operable to move the connection point 1235 joining the coupling joint 1238 to the spring-loaded assembly 1220. The distance defined between the connection point 1235 and the pivot axis A1 can be adjusted. Therefore, the corresponding perpendicular distance (D) between an extension of the force vector (V) and the pivot axis A1, which is used in the calculations of the torque, can also be adjusted. It should therefore be understood that the torque generated, which corresponds to the force (F) generated by the compression spring times the perpendicular distance (D) (i.e., T=F×D), can thereby be adjusted.

In this embodiment, the force adjuster 1290 includes an endless screw 1292 extending through and connecting the coupling joint 1238 to the spring-loaded assembly 1220. It is noted that the connection point 1235 is defined along the endless screw 1292, which can be moved along the endless screw 1292 upon rotation thereof. The force adjuster 1290 can include a knob 1294 to facilitate rotation of the endless screw 1292 for operation thereof. It should be noted that the knob and endless screw 1292 configuration allows for a continuous and meticulous adjustment of the position of the connection point 1235. The knob 1294 also allows for tooless manipulation of the force adjuster 1290, such as, by enabling manual (e.g. by hand) operation thereof.

For instance, rotating the knob 1294 and endless screw 1292 in a first direction can move the connection point 1235 closer waist anchor 1154, and therefore closer to the pivot axis A1, thereby decreasing the perpendicular distance therebetween and decreasing the generated torque. The force adjuster 1290 can be operated in this manner until a lower limit is reached (e.g., a minimum), corresponding to the shortest perpendicular distance (D) and the lowest generated torque, as illustrated in FIG. 34. Similarly, rotating the knob 1294 and endless screw 1292 in a second direction can move the connection point 1235 further from the waist anchor 1154, and therefore further from the pivot axis A1, thereby increasing the perpendicular distance therebetween and increasing the generated torque. The force adjuster 1290 can be operated in this manner until an upper limit is reached (e.g., a maximum), corresponding to the longest perpendicular distance (D) and the greatest generated torque, as illustrated in FIG. 36.

Similar to previously described embodiments, the coupling joint 1238 is connected to both actuator arms 1232 by a single cable 1236 at any given time. As such, the actuator system 1210 includes a distributor mechanism 1240 configured to distribute the force generated by the compression spring 1225 evenly between the actuator arms 1232. In other words, the cable is under tension and generates the same pulling force at either ends thereof to generate substantially the same torque. In this embodiment, the distributor mechanism 1240 includes a pulley 1242 through which the cable 1236 extends such that the same amount of cable tension is transmitted to each actuator arm 1232.

In this embodiment, the distributor mechanism 1240 is adapted to assist in enabling asymmetrical movements made by the user, such as lunges, or simply walking, where one leg is put in front of the other, for example. The distributor mechanism 1240 is configured to distribute the forces generated by the spring-loaded assembly evenly between the actuator arms, and therefore between the thighs of the user. Therefore, it is noted that, upon flexing one leg more than the other, for example, while kneeling on one knee, both thighs sustain substantially the same amount of force. The user can thus more easily maintain their balance and move unrestrained and unbothered by the exoskeleton as the distributor mechanism operates to dynamically distribute the forces to both thighs. The distributor mechanism can also increase an overall comfort level of the user, who can move in a more natural manner. It should be noted that other configurations of the distributor system are possible and may be implemented. For instance, the cable can be removed, and the spring-loaded assembly can be linked to the actuator links 1232 via one or more articulated and/or rigid connecting rods.

In this embodiment, the exoskeleton 1000 includes an adaptative system 1250 comprising adaptative links 252 configured to dynamically adjust relative distances at least between the interface anchors during movement of the user. This configuration enables the exoskeleton to be positioned along the user's back to free up the front and sides, which can allow for the use of accessories, such as tool belts, among others. The adaptative system 1250 is substantially the same as the one previously described and will not be described once again.

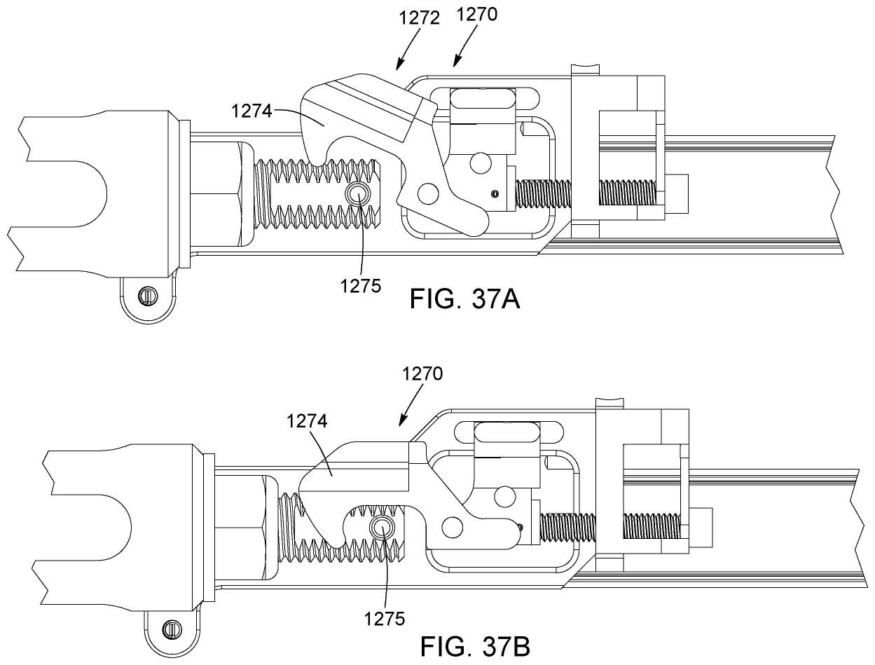

In some embodiments, and with reference to FIGS. 37A and 37B, the exoskeleton mechanism can include an activation mechanism 1270 configured to allow selective operation of the actuator system 1210. More specifically, the activation mechanism 1270 is operable between an engaged (or “on”) mode, and a disengaged (or “off”) mode. In some embodiments, the activation mechanism 1270 includes a latch mechanism 1272 operable to connect and disconnect the upper and lower sections 1202, 1204 of the exoskeleton mechanism 1200. It is appreciated that, by disconnecting the upper and lower sections of the exoskeleton mechanism, the generated forces and torques are prevented from being transferred to the upper section, and therefore do not assist the user. The latch mechanism 1272 includes a latch or hook 1274 configured to selectively connect to the spring-loaded assembly 1220. The hook 1274 is pivotally coupled to the upper section 1202 and operable to pivot between connected (FIG. 37B) and disconnected (FIG. 37A) configurations, which correspond to the engaged and disengaged modes of the activation mechanism 1270.

In this embodiment, the spring-loaded assembly 1220 includes a transverse bar 1275 onto which the hook 1274 can connect upon operation of the latch mechanism 1272 in the connection configuration. It should therefore be understood that the mechanical connection between the upper and lower sections of the exoskeleton is established upon the transverse bar 1275 abutting against the hook 1274 of the latch mechanism. Following this connection, the forces can be transferred from the lower section to the upper section, as previously described. In some embodiments, the latch mechanism 1272 can be manually operated to operate the activation mechanism 1270 in the desired mode. For example, the latch mechanism 1272 can be linked to the switch 300 (FIGS. 23 to 26) worn on a front side of the exoskeleton. The switch can be similar to the embodiment previously described, although other configurations are possible. It should be noted that, in some embodiments, even during operation of the activation mechanism in the disengaged/off mode, the exoskeleton mechanism provides some support and assistance to the user. For instance, the components of the upper and lower sections of the mechanism are still linked together, directly or indirectly, via other means. Therefore, the exoskeleton mechanism can be adapted to provide between 0% and 15% of the support provided when operating the activation mechanism in the engaged/on mode, for example.

The exoskeleton mechanism 1200 can further include an offset mechanism 1280 configured and operable to enable adjustment of the engagement angle of the exoskeleton mechanism 1200. In other words, the offset mechanism 1280 is operable to adjust the range of motion allowed prior to engaging the spring-loaded assembly 1220, and therefore adjust the range of motion allowed prior to putting the cable 1236 under tension. In this embodiment, the exoskeleton can initially be put on a user, and the offset mechanism 1280 can then be operated, as desired. For instance, the offset mechanism 1280 can be operated to reduce the range of motion required for engaging the spring-loaded assembly 1220 such that the exoskeleton provides support to the user as soon as movement is initiated (e.g., hip flexion). Inversely, the offset mechanism 1280 can be operated to increase the range of motion allowed prior the providing support to the user, providing the user a greater range of “unsupported” motion.

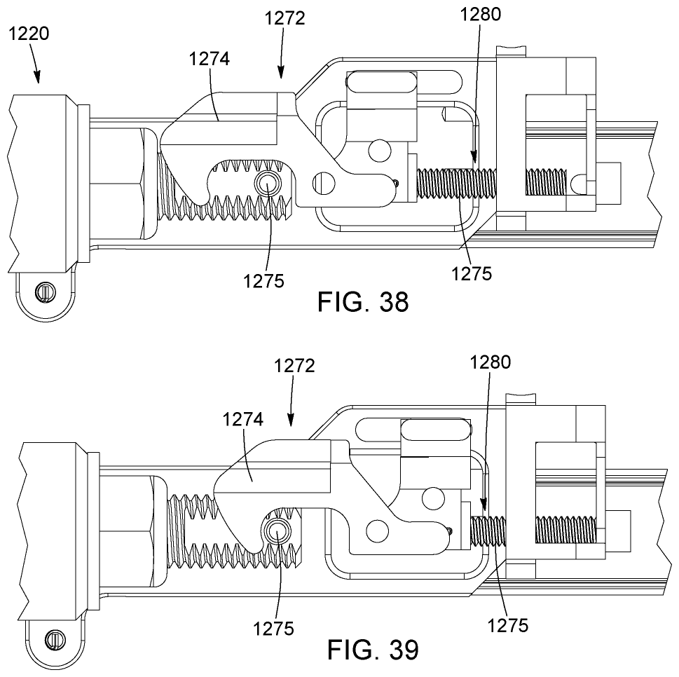

With reference to FIGS. 38 and 39, the offset mechanism 1280 is configured to adjust the position of the hook 1274 of the latch mechanism 1272 relative to the spring-loaded assembly 1220, and more specifically, relative to the transverse bar 1275. For example, operating the offset mechanism 1280 moves the hook axially to adjust a distance between the hook and the transverse bar. Therefore, the range of motion required to establish the mechanical connection between the upper and lower sections of the exoskeleton is correspondingly adjusted. For instance, increasing the distance between the transverse bar 1275 and the hook 1272, as seen in FIG. 38, correspondingly increases the range of motion required to establish the mechanical connection and enable force transmission. In a similar fashion, decreasing the distance between the transverse bar 1275 and the hook 1272, as seen in FIG. 39, correspondingly decreases the range of motion required to establish the mechanical connection and enable force transmission.

In some embodiments, the offset mechanism 1280 can therefore be adapted to define a predetermined and/or desired range of motion for operation of the exoskeleton mechanism 1200. The predetermined range of motion can correspond to a forward angular motion of the user (e.g., bending forward). The required angle at which the user bends forward can therefore be adjusted via operation of the offset mechanism. The offset mechanism 1280 can be operated the preemptively position the transverse bar 1275 and the hook 1272 in contact with one another, thereby enabling the transmission of forces as soon as movement is initiated. In such embodiments, it is noted that the required forward angular motion is substantially 0 degrees, since the transverse bar 1275 and the hook 1272 are already in contact. In this embodiment, the offset mechanism 1280 is adapted to be operated by hand, similar to previous embodiments.

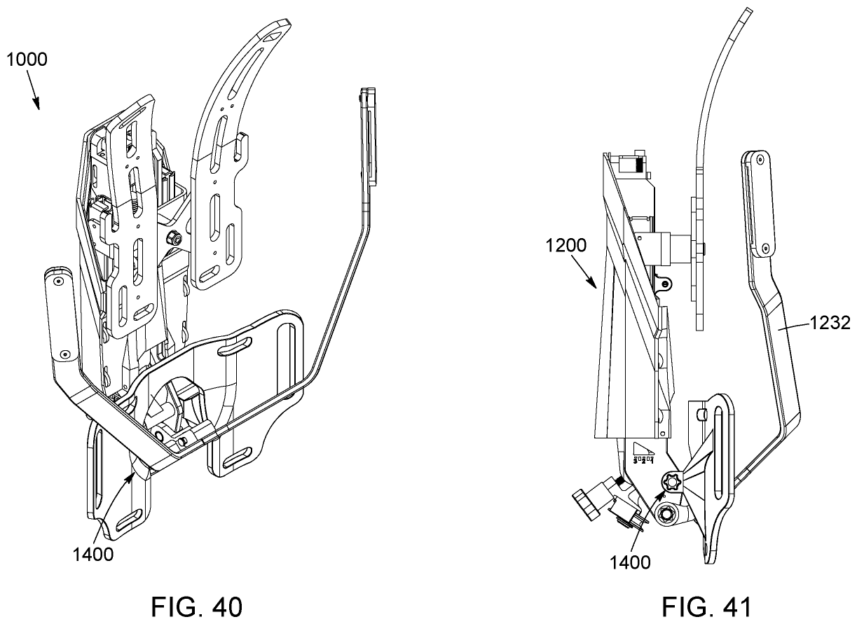

With reference to FIGS. 40 and 41, the exoskeleton 1000 includes a storage mechanism 1400 operable to fold at least some portions of the exoskeleton upon itself to reduce its overall size, reduce storage space requirements and/or facilitate transport and handling. In this embodiment, the storage mechanism 1400 enables the actuator arms 1232 to at least partially fold onto the spring-loaded assembly 1220. The shape and size of the actuator arms 1232 and the waist attachment can be at least partially complementary to allow sufficient movement of the actuator arms 1232 to fold onto the spring-loaded assembly.

The present disclosure may be embodied in other specific forms without departing from the subject matter of the claims. The described example embodiments are to be considered in all respects as being only illustrative and not restrictive. For example, the garment of the exoskeleton can be prefabricated to include additional components, such as pouches, loops, hooks, compartments, etc., which are generally found on tools belts, for example. Alternatively, the garment can be configured to have tool belts be mounted thereonto or have the waist attachment replaced by a tool belt, such as typical tool belts used on construction sites, for example.

In other embodiments, at least one or more systems or mechanisms of the exoskeleton can be motorized and/or remotely operated, such as by the user or another person or system, for example. The motorization of the various exoskeleton systems and mechanisms can include the activation mechanism, where the exoskeleton can be switch on or off remotely and/or automatically, for example. The offset mechanism can also include a motor operable to adjust the range of motion allowed prior to establishing the mechanical connection between the exoskeleton mechanism and the torso anchor. It is appreciated that other motorized and/or remote mechanisms can be incorporated in the exoskeleton to provide additional functionalities, improve existing functionalities and/or facilitate use and operation of the exoskeleton.

As used herein, the terms “coupled”, “coupling”, “attached”, “connected”, or variants thereof as used herein can have several different meanings depending in the context in which these terms are used. For example, the terms coupled, coupling, connected, or attached can have a mechanical connotation. For example, as used herein, the terms coupled, coupling, or attached can indicate that two elements or devices are directly connected to one another or connected to one another through one or more intermediate elements or devices via a mechanical element depending on the particular context.

It should be noted that, as used herein, the expressions “shortest”, “greatest”, “longest”, “lowest”, etc., are used in relation with the illustrated embodiment and should not be considered limiting. Similarly, positional descriptions such as “top”, “bottom”, “above”, “under”, “below”, “left”, “right”, “front”, “rear”, “parallel”, “perpendicular”, “transverse”, “inner”, “outer”, “internal”, “external”, and the like should, unless otherwise indicated, be taken in the context of the figures and should not be considered limiting.

In the present disclosure, an embodiment is an example or implementation of the exoskeleton. The various appearances of “one embodiment,” “an embodiment” or “some embodiments” do not necessarily all refer to the same embodiments. Although various features may be described in the context of a single embodiment, the features may also be provided separately or in any suitable combination. Conversely, although the exoskeleton and related components may be described herein in the context of separate embodiments for clarity, it may also be implemented in a single embodiment. Reference in the specification to “some embodiments”, “an embodiment”, “one embodiment”, or “other embodiments”, means that a particular feature, structure, or characteristic described in connection with the embodiments is included in at least some embodiments, but not necessarily in all embodiments.

In the above description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom.

In addition, although the optional configurations as illustrated in the accompanying drawings comprises various components and although the optional configurations of the exoskeleton and related components as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the implementation and use of the exoskeleton, and corresponding parts, as briefly explained and as can be easily inferred herefrom, without departing from the scope of the disclosure.

1. An exoskeleton, comprising:
a garment to be worn by a user, comprising:
a torso attachment to be worn around a torso;
a waist attachment to be worn around a waist; and
a pair of thigh attachments to be worn around corresponding thighs;
an exoskeleton interface, comprising:
a torso anchor connected to the torso attachment;
a waist anchor connected to the waist attachment; and
a pair of thigh anchors connected to respective thigh attachments, the torso anchor, the waist anchor and the pair of thigh anchors being provided on a backside of the user when wearing the garment;
an exoskeleton mechanism adapted to be connected to the garment via the exoskeleton interface, comprising:
an actuator system comprising:
a spring-loaded assembly having a casing adapted to be coupled the torso anchor and pivotally coupled to the waist anchor, and a resilient element connected to the casing, the spring-loaded assembly being operable to generate a force upon deformation or deflection of the resilient element; and
a pair of actuator links rotatably coupled to the waist anchor at a first end thereof, and connected to respective thigh anchors at a second end thereof, the pair of actuator links being operatively coupled to the spring-loaded assembly such that the spring-loaded assembly is operable upon rotation of at least one of the casing and either one or both of the pair of actuator links about the waist anchor, wherein the force generated upon operation of the spring-loaded assembly is transferred to the torso anchor and to the torso attachment to assist the user in performing a movement and/or a corresponding task.

2. The exoskeleton of claim 1, wherein the exoskeleton mechanism further comprises an adaptative system comprising adaptative links configured to dynamically adjust the relative distances between at least two of the torso anchor, the waist anchor and the thigh anchors during movement of the user.

3. The exoskeleton of claim 2, wherein the adaptative links comprise at least one of a sliding link configured to adjust a distance between two of the anchors and a pivot link configured to adjust an angle between two of the anchors.

4. The exoskeleton of claim 3, wherein the sliding link comprises a pair of complementing rails shaped and adapted to slide along one another.

5. The exoskeleton of claim 3 or 4, wherein the torso anchor and the waist anchor are coupled together by at least one sliding link configured to adjust a distance therebetween.

6. The exoskeleton of any one of claims 3 to 5, wherein the torso anchor and the waist anchor are coupled together by at least a first pivot link defining a pivot axis and enabling relative rotation of the torso anchor and the waist anchor about the pivot axis.

7. The exoskeleton of claim 6, wherein each one of the pair of actuator links and the waist anchor are coupled together at the first pivot link to enable rotation of the actuator links about the first pivot axis.

8. The exoskeleton of claim 6, wherein each one of the pair of actuator links are pivotally coupled to the waist anchor at respective pivot joints such that each actuator link is adapted to pivot about respective pivot axes.

9. The exoskeleton of claim 8, wherein each pivot axis is parallel relative to one another.

10. The exoskeleton of claim 8 or 9, wherein each pivot axis is aligned with one another.

11. The exoskeleton of any one of claims 6 to 10, wherein each one of the pair of actuator links and the waist anchor are coupled together by respective second pivot links defining second pivot axes and enabling rotation of the pair of actuator links about a corresponding one of the second pivot axes.

12. The exoskeleton of claim 11, wherein the second pivot axes are substantially perpendicular to the first pivot axis.

13. The exoskeleton of any one of claims 1 to 12, wherein the actuator system comprises a coupling joint connected to the resilient element of the spring-loaded assembly at a connection point, and further comprises a spring actuator operatively coupled between the actuator links and the coupling joint to establish an operational connection between the actuator links and the spring-loaded assembly.

14. The exoskeleton of claim 13, wherein the spring actuator comprises a cable extending between the actuator links and the coupling joint, wherein rotation of the actuator links tensions the cable and pulls on the coupling joint and the resilient element, thereby generating the force by deformation or deflection of the resilient element.

15. The exoskeleton of claim 14, wherein the spring actuator comprises a single cable extending from a first one of the pair of actuator links, through the coupling joint and to a second one of the pair of actuator links.

16. The exoskeleton of claim 14 or 15, wherein the coupling joint is pivotally coupled to the waist anchor at a coupling pivot link, and wherein the resilient element, when deformed or deflected, defines an axial force adapted to generate a torque about the coupling pivot link.

17. The exoskeleton of claim 16, wherein the casing of the spring-loaded assembly is adapted to transfer the torque to the torso anchor and the torso attachment.

18. The exoskeleton of claim 16 or 17, wherein the actuator system comprises a force adjuster selectively operable to adjust a distance between the resilient element and the waist anchor in order to adjust the torque generated by the axial force generated by the resilient element.

19. The exoskeleton of claim 18, wherein the force adjuster is operable to move the connection point joining the coupling joint to the spring-loaded assembly relative to the coupling pivot link.

20. The exoskeleton of claim 18 or 19, wherein the force adjuster is toolessly operable.

21. The exoskeleton of any one of claims 18 to 20, wherein the force adjuster comprises an endless screw extending through and connecting the coupling joint to the spring-loaded assembly, the connection point being defined along the endless screw, and wherein rotation of the endless screw adjusts the position of the connection point therealong.

22. The exoskeleton of any one of claims 1 to 21, wherein the actuator system comprises a distributor mechanism configured to distribute the force generated by the spring-loaded assembly substantially evenly between each one of the pair of actuator links such that a substantially even force is transferred to each one of the thigh attachments.

23. The exoskeleton of claim 22, wherein the distributor mechanism comprises a pulley mounted to the coupling joint, and wherein the cable extends from the first one of the pair of actuator links, through the pulley and the coupling joint and to the second one of the pair of actuator links.

24. The exoskeleton of any one of claims 1 to 23, wherein the exoskeleton mechanism further comprises an activation mechanism selectively operable between an engaged mode, where operation of the exoskeleton mechanism is enabled to allow the force generated upon operation of the spring-loaded assembly to define a transferred force transferrable to the torso anchor and to the torso attachment to assist the user, and a disengaged mode.

25. The exoskeleton of claim 24, wherein the exoskeleton mechanism is adapted to transfer between 0% and 15% of the transferred force to the torso anchor and to the torso attachment when operating the activation mechanism in the disengaged mode.

26. The exoskeleton of claim 24 or 25, wherein operation of the activation mechanism in the engaged mode establishes a direct mechanical connection between the torso anchor and the spring-loaded assembly to enable transfer of the transferred force, and wherein operation of the activation mechanism in the disengaged mode breaks the direct mechanical connection between the torso anchor and the spring-loaded assembly, thereby preventing a complete transfer of the transferred force.

27. The exoskeleton of any one of claim 24 or 26, wherein the activation mechanism comprises a hook coupled to the torso anchor and adapted to connect to a latch of the spring-loaded assembly when operating the activation mechanism in the engaged mode.

28. The exoskeleton of any one of claims 24 to 27, wherein the activation mechanism is toolessly operable between the engaged and disengaged modes.

29. The exoskeleton of claim 27 or 28, wherein the activation mechanism comprises a switch operatively coupled to the hook and being selectively operable to actuate the hook to operate the activation mechanism in a desired one of the engaged and disengaged modes.

30. The exoskeleton of claim 29, wherein the switch is connected to the hook via a wire, and wherein the switch is manually displaceable to effect rotation of the hook to operate the activation mechanism between the engaged and disengaged modes.

31. The exoskeleton of claim 30, wherein the switch is adapted to be worn on the garment to facilitate access.

32. The exoskeleton of any one of claims 1 to 31, wherein the exoskeleton mechanism is adapted to define a mechanical connection with the torso anchor during movement of the user to enable the transfer of the force generated by the spring-loaded assembly to the torso anchor and to the torso attachment, and wherein the exoskeleton mechanism further comprises an offset mechanism operable to adjust a range of motion allowed by the user prior to defining the mechanical connection between the torso anchor and the exoskeleton mechanism.

33. The exoskeleton of claim 32, wherein the offset mechanism comprises a set screw coupled to one of the torso anchor and the exoskeleton mechanism and being rotatable to adjust a relative distance between the torso anchor and the exoskeleton mechanism.

34. The exoskeleton of claim 32 or 33, wherein the offset mechanism is toolessly operable.

35. The exoskeleton of any one of claims 1 to 34, wherein the resilient element comprises at least one of a spring, a piston, a gas cylinder, an elastic or a combination thereof.

36. The exoskeleton of any one of claims 1 to 35, wherein the torso anchor comprises an upper support plate connected to the torso attachment and configured to engage the user's back proximate the shoulder blades.

37. The exoskeleton of claim 36, wherein the upper support plate comprises a pair of upper back plates spaced from one another to define a gap therebetween, and wherein the pair of upper back plates are configured to engage the user's back to align a spine of the user with the gap to at least partially prevent applying pressure to the spine.

38. The exoskeleton of any one of claims 1 to 37, wherein the waist anchor comprises a lower support plate connected to the waist attachment and configured to engage the user's lumbar region.

39. The exoskeleton of claim 38, wherein the lower support plate comprises a pair of lateral wings spaced from one another to define a gap therebetween, and wherein the pair of lateral wings are configured to engage the user's lumbar region on respective sides of a spine of the user to at least partially prevent applying pressure to the spine.

40. The exoskeleton of any one of claims 1 to 39, wherein the waist attachment corresponds to a tool belt or is adapted to be replaced by a tool belt.

41. The exoskeleton of any one of claims 1 to 40, wherein the exoskeleton mechanism is configured to be contained on the backside of the user when wearing the garment in order to free up front and lateral sides of the user.

42. The exoskeleton of any one of claims 1 to 41, wherein the exoskeleton mechanism is configurable between an operational configuration, where the pair of actuator links extend downwardly from a bottom end of the spring-loaded assembly, and a stowed configuration, where the actuator links extend upwardly from the bottom end of the spring-loaded assembly.

43. The exoskeleton of claim 42, wherein the pair of actuator links are pivotable relative to the spring-loaded assembly to enable folding the exoskeleton from the operational configuration to the stowed configuration.
